(19) United States
(12) Patent Application Publication
(10) Pub. No.: US 2011/0205428 A1
(43) Pub. Date: Aug. 25, 2011

(54) TRANSMISSION APPARATUS, TRANSMISSION METHOD, RECEPTION APPARATUS, RECEPTION METHOD AND SIGNAL TRANSMISSION SYSTEM

(76) Inventor: Shigeyuki YAMASHITA, Kanagawa (JP)

(21) Appl. No.: 13/030,205

(22) Filed: Feb. 18, 2011

(30) Foreign Application Priority Data
Feb. 24, 2010 (JP) P2010-039298

(51) Int. Cl. H04N 7/01

(52) U.S. Cl. 348/443; 348/E07.008; 348/E07.004

(57) ABSTRACT

Disclosed herein is a signal transmission apparatus, including: a two-pixel sampling out control section adapted to sample out, from among pixel samples extracted from a class image defined by a 3840×2160/100P, 119.88P, 120P/4:4:4, 4:2:2, 4:2:0/10-bit, 12-bit signal of the UHDTV1 wherein the pixel number of one frame exceeds a pixel number prescribed by the HD-SDI format, two pixel samples adjacent each other on the same line such that the pixel samples on each odd-numbered line of each frame are sampled out to a first sub image and a second sub image from among first to fourth sub images and the pixel samples on each even-numbered line of each frame are sampled out to the third sub image and the fourth sub image; a line sampling out control section; a field sampling out control section; a word sampling out control section; and a readout control section.

### BACKGROUND OF THE INVENTION

1. Field of the Invention

This invention relates to a transmission apparatus, a transmission method, a reception apparatus, a reception method and a signal transmission system which can be suitably applied to a case in which an image signal with regard to which the pixel number of one frame exceeds the number of pixels prescribed by the HD-SDI (High Definition Signal Digital Interface) format is serially transmitted.

2. Description of the Related Art

Development of a reception system or an image pickup system for a very high definition video signal which exceeds a high definition (HD) signal which is an existing image signal or video signal with regard to which one frame has 1,920 samples×1,080 lines is proceeding. For example, a UHDTV (Ultra High Definition TV) standard which is a broadcasting system of a next generation having a number of pixels equal to four times or 16 times that of the existing HD is being standardized by international associations. The international associations include the ITU (International Telecommunication Union) and the SMPTE (Society of Motion Picture and Television Engineers).

The video standard proposed by the ITU or the SMPTE relates to an image signal having a sample number and a line number equal to twice or four times those of 1,920 samples×1,080 lines, that is, having 3,840 samples×2,160 lines or 7,680 samples×4,320 lines. That one of the video signals which is standardized by the ITU is called LSDI (Large Screen Digital Imagery) while that one which is proposed by the SMPTE is called UHDTV. As regards the UHDTV, signals of the following table 1 are prescribed.

TABLE 1

| | | | Effective | Frame |
|---|---|---|---|---|
| System | | Luminance or R′G′B′ sample | line number | rate |
| category | System name | number per effective line | per frame | (Hz) |
| UHDTV1 | 3840 × 2160/50/P | 3840 | 2160 | 50 |
| | 3840 × 2160/59.94/P | 3840 | 2160 | 60/1.001 |
| | 3840 × 2160/60/P | 3840 | 2160 | 60 |
| UHDTV2 | 7680 × 4320/50/P | 7680 | 4320 | 50 |
| | 7680 × 4320/59.94/P | 7680 | 4320 | 60/1.001 |
| | 7680 × 4320/60/P | 7680 | 4320 | 60 |

Then, upon product development directed to 3,840×2160/60P, products at an initial stage are estimated as video apparatus compatible with 3840×2160/24P, 25P and 30P. In addition, it is demanded to supply the market with products ready for such a frame rate other than 30P such as 24P by looking for an application which can utilize various 4k images.

As an interface for them, a transmission standard known as mode D is added to the SMPTE 430-2, and standardization is completed as SMPTE 435-2-2009. On the basis of this system, according to the UHDTV standard, a system wherein 3840×2160/60P transmits a signal of 10 Gbps by two channels and 7680/4320/60P transmits a signal of 10 Gbps by eight channels is proposed as SMPTE 2036-3 by the SMPTE.

FIG. 16 illustrates the method of the mode D.

The mode D is a method of multiplexing HD-SDIs of eight channels CH1 to CH8.

In the mode D, data are multiplexed into the video data region and the horizontal auxiliary data space of a 10.692 Gbps stream. At this time, the video/EAV/SAV data of the HD-SDIs of the channels CH1, CH3, CH5 and CH7 are extracted by 40 bits and scrambled so as to be converted into data of 40 bits. Meanwhile, the video/EAV/SAV data of the HD-SDIs of the channels CH2, CH4, CH6 and CH8 are extracted by 32 bits and converted into data of 40 bits by 8B/10B conversion. The data are added to each other to form data of 80 bits. The encoded 8-word or 80-bit data is multiplexed into the video data region of the 10.692 Gbps stream.

At this time, to the front half data block of 40 bits from within the data block of 80 bits, the data block of 40 bits of the even-numbered channels obtained by the 8B/10B conversion is allocated. Then, to the rear half data block of 40 bits, the data block of scrambled 40 bits of the odd-numbered channels is allocated. Therefore, in the one data block, for example, the data blocks are multiplexed in the order of, for example, the channels CH2 and CH1. The reason why the order is changed in this manner is that a content ID for identifying a mode to be used is included in the data block of 40 bits of the even-numbered channels obtained by the 8B/10B conversion.

Meanwhile, the horizontal auxiliary data space of the HD-SDI of the channel CH1 is subjected to 8B/10B conversion and encoded into a data block of 50 bits. Then, the data block is multiplexed into the horizontal auxiliary data space of the 10.692 Gbps stream. It is to be noted that the horizontal auxiliary data spaces of the HD-SDI of the channels CH2 to CH8 are not transmitted.

Meanwhile, Japanese Patent Laid-Open No. 2005-328494 discloses a technique for transmitting a 3840×2160/30P, 30/1.001P/4:4:4/12-bit signal, which is a kind of a 4k×2k signal which is a very high resolution signal of 4k samples×2k lines at a bit rate equal to or higher than 10 Gbps. It is to be noted that the term “3840×2160/30P” indicates a “pixel number in the horizontal direction”×“line number in the vertical direction”/“frame number per one second.” Further, “4:4:4” represents the ratio of a “red signal R: green signal G: blue signal B” in the case of the primary color signal transmission method or the ratio of a “luminance signal Y: first color difference signal Cb: second color difference signal Cr” in the case of the color difference signal transmission method.

### SUMMARY OF THE INVENTION

Incidentally, a video signal standard or an interface standard for up to 60P of 3840 samples×2160 lines or 7680 samples×4320 lines is being standardized by the SMPTE or the ITU. However, no argument or no standardization is made in regard to an interface of a signal compatible with 120P.

Therefore, it is desirable to provide a transmission apparatus, a transmission method, a reception apparatus, a reception method and a signal transmission system by which an image signal wherein the pixel number in one frame exceeds a pixel number prescribed by an HD-SDI format can be transmitted serially at a bit rate equal to or higher than 10.692 Gbps.

The present invention is applied where a class image is involved which is prescribed by the UHDTV1 and wherein the pixel number of one frame exceeds a pixel number prescribed by the HD-SDI format. At this time, according to a first embodiment of the present invention, pixel samples are extracted from a class image which is a 3840×2160/100P, 119.88P, 12OP/4:4:4, 4:2:2, 4:2:0/10-bit, 12-bit signal of the UHDTV1.

Then, two pixel samples adjacent each other on the same line are sampled out such that the pixel samples on each odd-numbered line of each frame are sampled out alternatively to a first sub image and a second sub image from among first to fourth sub images. Further, the pixel samples on each even-numbered line of each frame are sampled out alternatively to the third sub image and the fourth sub image.

Thereafter, the pixel samples in every other line of the mapped first to fourth sub images are sampled out to form interlace signals, and the pixel samples sampled out for every other line are sampled out for each field.

Then, the pixel samples sampled out for each field are sampled out for each word to map the pixel samples to an active period of HD-SDIs of the mode D prescribed by the SMPTE 435-2, and the HD-SDIs are outputted.

According to another embodiment of the present invention, HD-SDIs of the mode D prescribed by the SMPTE 435-2 are stored into a storage section, and pixel samples extracted from an active period of the HD-SDIs read out from the storage section are multiplexed for each word.

Then, the pixel samples multiplexed for each word are multiplexed for each field.

Thereafter, the pixel samples multiplexed for each field are multiplexed to first to fourth sub images for each line to produce progressive signals.

Then, the pixel samples extracted two by two pixels from the first sub image and the second sub image are multiplexed in an adjacent relationship to each other on odd-numbered lines in a class image prescribed by the UHDTV1. This class image is an image signal which is a 3840×2160/100P, 119.88P, 120P/4:4:4, 4:2:2, 4:2:0/10-bit, 12-bit signal of the UHDTV1.

Then, the pixel samples extracted two by two pixels from the third sub image and the fourth sub image are multiplexed in an adjacent relationship to each other on even-numbered lines of the frame.

In the present invention, a signal inputted is subjected to two-pixel sampling out, line sampling out, field sampling out and word sampling out, and a signal wherein pixel samples are multiplexed in an active period of HD-SDIs of the mode D is transmitted. Meanwhile, the signal received is subjected to extraction of the pixel samples from the active period of the HD-SDIs and further subjected to word multiplexing, field multiplexing, line multiplexing and two-pixel multiplexing to reproduce the signal.

According to the embodiments of the present invention, when a 3840×2160/100P, 119.88P, 120P/4:4:4, 4:2:2, 4:2:0/10-bit, 12-bit signal of the UHDTV1 is to be transmitted, various sampling out processes are carried out to map pixel samples to an active period of HD-SDIs of the mode D. On the other hand, the pixel samples are extracted from the active period of the HD-SDIs, and various multiplexing processes are carried out for the pixel samples to the reproduce the 3840×2160/100P, 119.88P, 120P/4:4:4, 4:2:2, 4:2:0/10-bit, 12-bit signal. Therefore, an image signal wherein the pixel number of one frame exceeds the pixel number prescribed by the HD-SDI format can be transmitted and received. Further, since a transmission line used in the past can be utilized without provision of a new transmission line, there is an effect that the convenience is enhanced.

The above and other features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a schematic view showing a general configuration of a camera transmission system for a television broadcasting station according to a first embodiment of the present invention;

FIG. 2 is a block diagram showing an example of an internal configuration of a signal transmission apparatus in a circuit configuration of a broadcasting camera shown in FIG. 1;

FIG. 3 is a block diagram showing an example of an internal configuration of a mapping section shown in FIG. 2;

FIG. 4 is a diagrammatic view illustrating an example of a data structure for one line of serial digital data of 10.692 Gbps in the case of 24P;

FIGS. 5A to 5C are schematic views illustrating examples of a sample structure of the UHDTV standard;

FIG. 6 is a diagrammatic view illustrating processing by the mapping section of FIG. 3 when it maps pixel samples two by two pixels;

FIG. 7 is a similar view but illustrating an example wherein pixel samples are sampled out two by two pixels to map the pixel samples to sub images;

FIG. 8 is a diagrammatic view illustrating an example of line sampling out of first to fourth sub images to which pixel samples are mapped by the mapping section of FIG. 3;

FIG. 9 is a diagrammatic view illustrating an example of field sampling out of pixel samples after the line sampling out illustrated in FIG. 8;

FIG. 10 is a diagrammatic view illustrating an example wherein first to fourth sub images to which pixel samples are mapped are divisionally mapped to a link A and a link B in accordance with a prescription of the SMPTE 372M;

FIG. 11 is a block diagram showing an example of an internal configuration of a signal reception apparatus in the circuit configuration of a CCU shown in FIG. 1;

FIG. 12 is a block diagram showing an example of an internal configuration of a reproduction section shown in FIG. 11;

FIG. 13 is a diagrammatic view illustrating processing by the mapping section of FIG. 3 when it maps pixel samples;

FIG. 14 is a block diagram showing an example of an internal configuration of a mapping section according to a second embodiment of the present invention;

FIG. 15 is a block diagram showing an example of an internal configuration of a reproduction section according to the second embodiment of the present invention; and

FIG. 16 is a diagrammatic view illustrating an example of the mode D.

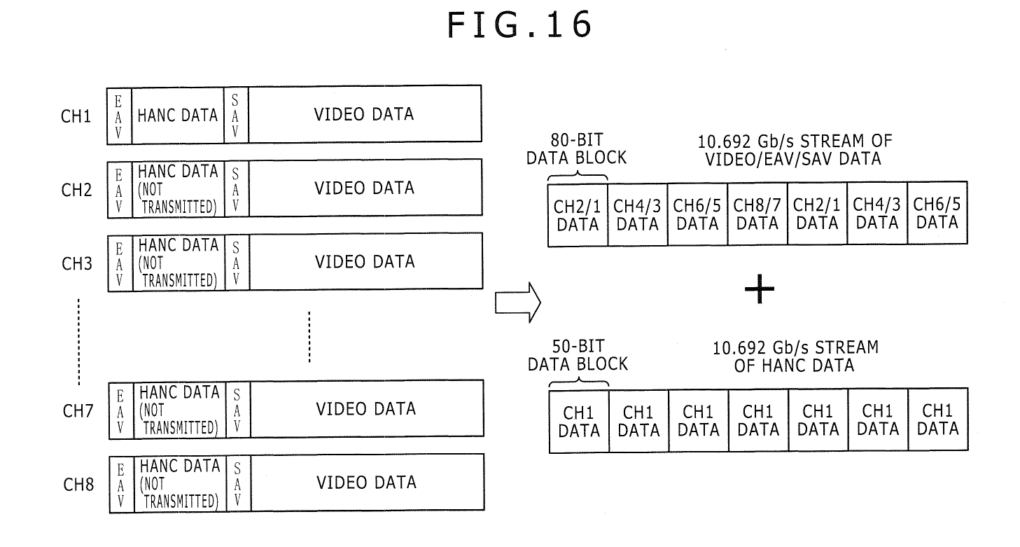

### DETAILED DESCRIPTION OF THE PREFERRED EMBODIMENTS

In the following, preferred embodiments of the present invention are described. It is to be noted that the description is given in the following order.
1. First Embodiment (mapping control of pixel samples: example of 3840×2160/100P-120P/4:4:4, 4:2:2, 4:2:0/10 bits, 12 bits)
2. Second Embodiment (example of UHDTV2 7680×4320/100P, 119.88, 120P/4:4:4, 4:2:2, 4:2:0/10 bits, 12 bits)

### 1. First Embodiment

### Example of 3840×2160/100P-120P/4:4:4, 4:2:2, 4:2:0/10 Bits, 12 Bits]

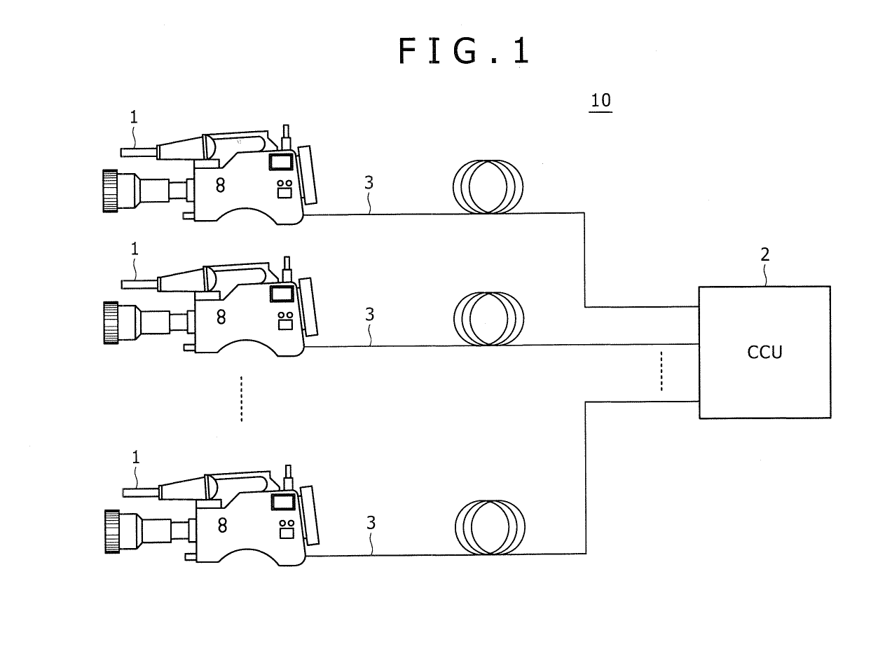

In the following, a first embodiment of the present invention is described with reference to FIGS. 1 to 12.

Here, a method of sampling out pixel samples of a 3840×2160/100P, 119.88P, 120P/4:4:4, 4:2:2, 4:2:0/10-bit, 12-bit signal is described. In the following description, 100P, 119.88P, 120P are sometimes referred to simply as “100P-120P.” Further, the 3840×2160/100P-120P/4:4:4, 4:2:2, 4:2:0/10-bit, 12-bit signal is sometimes referred to simply as “3840×2160/100P-120P signal.”

FIG. 1 shows a general configuration of a signal transmission system 10 for a television broadcasting station to which the present embodiment is applied. Referring to FIG. 1, the signal transmission system 10 is configured from a plurality of broadcasting cameras 1 and a camera control unit (CCU) 2. The broadcasting cameras 1 are connected to the CCU 2 by respective optical fiber cables 3. Each of the broadcasting cameras 1 is used as a signal transmission apparatus to which a signal transmission method for transmitting a serial digital signal is applied, and the CCU 2 is used as a signal reception apparatus to which a signal reception method for receiving the serial digital signal is applied. Further, the signal transmission system 10 which includes the combination of the broadcasting cameras 1 and the CCU 2 is used as a signal transmission system for transmitting and receiving a serial digital signal.

The broadcasting cameras 1 have the same configuration thereamong. The broadcasting cameras 1 function as signal transmission apparatus which generate a 3840×2160/100P-120P/4:4:4, 4:2:2, 4:2:0/10-bit, 12-bit signal as a 4k×2k signal. In the following description, a very high resolution signal of 4k samples×2k lines is referred to as “4k×2k signal.”

The CCU 2 is a unit which controls the broadcasting cameras 1, receives image signals from the broadcasting cameras 1 and transmits an image signal (return video) for causing a monitor of each broadcasting camera 1 to display images during image pickup by the other broadcasting cameras 1. The CCU 2 functions as a signal reception apparatus for receiving image signals from the broadcasting cameras 1.

### <DWDM/CWDM Wavelength Multiplexing Transmission Technique>

Here, a DWDM/CWDM wavelength multiplexing transmission technique is described.

A method of multiplexing and transmitting light of a plurality of wavelengths through a single optical fiber is called WDM (Wavelength Division Multiplexing). The WDM is roughly divided into the following three methods depending upon the wavelength distance.

### (1) Two-Wavelength Multiplexing Method

Two or three waves spaced from each other like 1.3 μm and 1.55 μm are multiplexed and transmitted by a single optical fiber.

### (2) DWDM (Dense Wavelength Division Multiplexing) Method

A method of multiplexing and transmitting light in a high density at such intervals of 25 GHz, 50 GHz, 100 GHz or 200 GHz in light frequency or of approximately 0.2 nm, 0.4 nm or 0.8 nm in light wavelength particularly in the 1.55 μm band is called DWDM. Standardization of the center frequency and so forth has been carried out by the ITU-T (International Telecommunication Union Telecommunication standardization sector). Since the wavelength interval of the DWDM is as narrow as 100 GHz, the number of waves to be multiplexed can be made as great as several tens to hundred and communication of a very high capacity can be anticipated. However, since it is necessary for the oscillation wavelength width to be sufficiently narrower than the wavelength interval of 100 GHz and besides it is necessary for the temperature of the semiconductor laser to be controlled so that the center frequencies may comply with the ITU-T standard, a high cost is required for the device and high power consumption is required for the system.

### (3) CWDM (Coarse Wavelength Division Multiplexing) Method

On the other hand, in recent years, attention has been and is being given to a wavelength multiplexing technique called CWDM wherein the wavelength interval is set to 10 to 20 nm which is greater by more than one digit than that in the DWDM. Since the wavelength interval is comparatively great, there is no necessity to set the oscillation wavelength band width of the semiconductor layer so narrow as that in the DWDM and there is no necessity to control the temperature of the semiconductor laser either. Therefore, it is possible to configure the system at a low cost and with low power consumption. This technique is effectively applicable to a system which dose not need a large capacity as DWDM. As regards the center frequencies, in the case of a 4-channel configuration, for example, 1.511 μm, 1.531 μm, 1.551 μm and 1.571 μm are currently applied popularly, and in the case of an 8-channel configuration, for example, 1.471 μm, 1.491 μm, 1.511 μm, 1.531 μm, 1.551 μm, 1.571 μm, 1.591 μm and 1.611 μm are currently applied popularly.

The 3840×2160/100P-120P/4:4:4, 4:2:2, 4:2:0/10-bit, 12-bit signal used in the present example is a signal of a frame rate equal to that of a signal prescribed by the S2036-1. The signal prescribed by the S2036-1 is a 3840×2160/50P, 59.94P, 60P/4:4:4, 4:2:2, 4:2:0/10-bit, 12-bit signal. Thus, the digital signal form regarding inhibition codes and so forth is same as that of an existing signal prescribed by the S2036-1. In the following description, 50P, 59.94P, 60P are sometimes referred to simply as “50P-60P.”

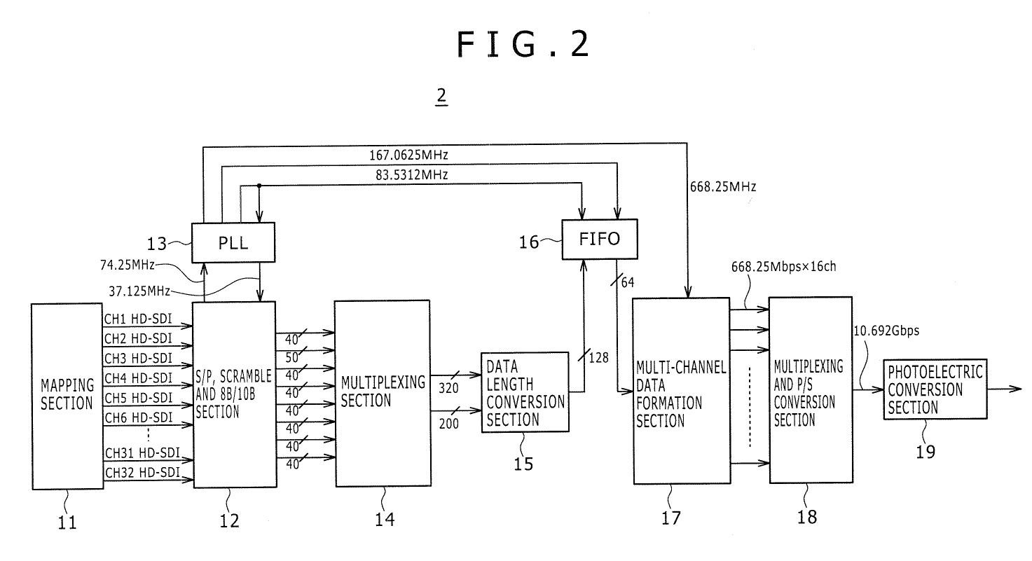

FIG. 2 shows a signal transmission apparatus which relates to the present embodiment from within a circuit configuration of the broadcasting camera 1. A 3840×2160/100P-120P/4:4:4, 4:2:2, 4:2:0/10-bit, 12-bit signal produced by an image pickup section and an image signal processing section both not shown in the broadcasting camera 1 is sent to a mapping section 11.

The 3840×2160/100P-120P/4:4:4, 4:2:2, 4:2:0/10-bit, 12-bit signal is a signal of a 36-bit width wherein a G data sequence, a B data sequence and an R data sequence all having a word length of 12 bits are disposed in parallel and in synchronism with each other. The one frame period is 1/100, 1/119.88 or 1/120 second and includes a period of 2,160 effective lines. The pixel number of one frame of the image signal exceeds the pixel number prescribed by the HD-SDI format. Then, an audio signal is inputted in synchronism with the image signal.

In each effective line period, a timing reference signal EAV (End of Active Video), a line number LN, an error detection code CRC and a horizontal auxiliary data space (period for auxiliary/undefined word data) are placed. Further, within each effective line period, a timing reference signal SAV (Start of Active Video) and an active line which is an interval of image data are placed. The sample number of the active line is 4096, and image data of G, B and R are disposed in the active lines of the G data sequence, B data sequence and R data sequence, respectively.

The mapping section 11 maps the 3840×2160/100P -120P/4:4:4, 4:2:2, 4:2:0/10-bit, 12-bit signal to a transmission stream of 32 channels prescribed by the HD-SDI format.

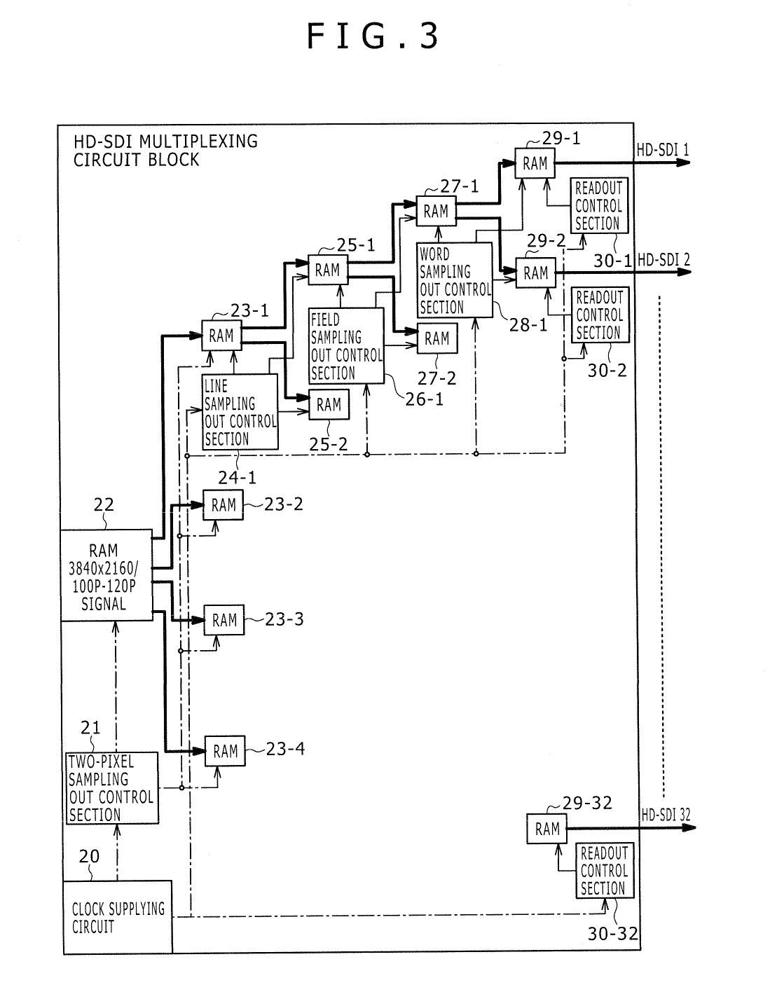

FIG. 3 shows an example of an internal configuration of the mapping section 11.

Referring to FIG. 3, the mapping section 11 includes a clock supplying circuit 20 for supplying a clock to components of the mapping section 11, and a RAM 22 for storing a 3840×2160/100P-120P video signal. Further, the mapping section 11 includes a two-pixel sampling out control section 21 for controlling two-pixel sampling out (interleave) for reading out pixel samples by two pixels from the RAM 22, and RAMs 23-1 to 23-4 for storing the pixel samples sampled out by two pixels.

Further, the mapping section 11 includes line sampling out control sections 24-1 to 24-4 for carrying out line sampling out of data read out from the RAMs 23-1 to 23-4, respectively, and RAMs 25-1 to 25-16 into which data temporarily sampled out by the line sampling out control sections 24-1 to 24-4 are written.

Further, the mapping section 11 includes field sampling out control sections 26-1 to 26-8 for controlling field sampling out of data read out from the RAMs 25-1 to 25-16. The mapping section 11 further includes RAMs 27-1 to 27-16 into which data temporarily sampled out by the field sampling control sections 26-1 to 26-8 are written.

The mapping section 11 further includes word sampling out control sections 28-1 to 28-16 for controlling word sampling out of data read out from the RAMs 27-1 to 27-16. The mapping section 11 further includes RAMs 29-1 to 29-32 into which data temporarily sampled out by the word sampling out control sections 28-1 to 28-16 are written.

Further, the mapping section 11 includes readout control sections 30-1 to 30-32 for outputting pixel samples of data read out from the RAMs 29-1 to 29-32 as HD-SDIs of 32 channels.

It is to be noted that, while FIG. 3 shows blocks for producing the HD-SDI 1, also blocks for producing HD-SDIs 2 to 32 have a similar configuration, and therefore, illustration and detailed overlapping description of the blocks are omitted.

The clock supplying circuit 20 supplies a clock to the two-pixel sampling out control section 21, line sampling out control sections 24-1 to 24-4, field sampling out control sections 26-1 to 26-8, word sampling out control sections 28-1 to 28-16 and readout control sections 30-1 to 30-32. The clock is used for reading out or writing of pixel samples, and the blocks mentioned of the mapping section 11 operate in synchronism with each other.

An image signal of the UHDTV1 inputted from an image sensor not shown and having a pixel number of one frame which exceeds a pixel number prescribed by the HD-SDI format whose pixel number of one frame is 3840 in the maximum×2160 in the maximum is stored into the RAM 22. The image signal of the UHDTV1 is a 3840×2160/100P, 119.88P, 120P/4:4:4, 4:2:2, 4:2:0/10-bit, 12-bit signal. The image signal is a class image prescribed by the UHDTV1.

The two-pixel sampling out control section 21 samples out two pixel samples adjacent each other on the same line from among pixel samples extracted from each frame defined by the image signal by a method prescribed by the SMPTE 435-1. Then, the two-pixel sampling out control section 21 samples out the pixel samples on odd-numbered lines of each frame from within first to fourth sub images alternately into the first sub image and the second sub image to map them. Similarly, the two-pixel sampling out control section 21 samples out the pixel samples on even-numbered lines of each frame alternately into the third sub image and the fourth sub image.

In particular, the two-pixel sampling out control section 21 carries out controlling to extract a 3840×2160/100P-120P video signal two by two pixels in a line direction for each two upwardly and downwardly adjacent lines and write the read out video signal into the RAMs 23-1 to 23-4. At this time, the two-pixel sampling out control section 21 forms the first to fourth sub images corresponding to 1920×1080/100P-120P prescribed by the SMPTE 435-1 in the RAMs 23-1 to 23-4.

The line sampling out control sections 24-1 to 24-4 convert a progressive signal into an interlace signal. In particular, the line sampling out control sections 24-1 to 24-4 read out the first to fourth sub images mapped by the two-pixel sampling out control section 21 and stored in the RAMs 23-1 to 23-4. At this time, the line sampling out control sections 24-1 to 24-4 convert one sub image into 1920×1080/100I, 119.88I, 120I/4:4:4, 4:2:2, 4:2:0/10-bit, 12-bit signals of two channels. In the following description, 100I, 119.88I, 120I are sometimes referred to simply as “100I-120I.” Then, the line sampling out control sections 24-1 to 24-4 sample out every other line from the read out first to fourth sub images to form a 1920×1080/100I-120I signal in the form of an interlace signal and store the thus produced 1920×1080/100I-120I signals into the RAMs 25-1 to 25-8.

The field sampling out control sections 26-1 to 26-4 read out line-sampled out pixel samples from the RAMs 25-1 to 25-8. At this time, the field sampling out control sections 26-1 to 26-4 convert a 1920×1080/100I-120I/4:4:4, 4:2:2, 4:2:0/10-bit, 12-bit signal of one channel into the following signal. In particular, the field sampling out control sections 26-1 to 26-4 convert the 1920×1080/100I-120I/4:4:4, 4:2:2, 4:2:0/10-bit, 12-bit signal into 1920×1080/50I-60I/4:4:4, 4:2:2, 4:2:0/10-bit, 12-bit signals of two channels for each field. Then, the field sampling out control sections 26-1 to 26-4 sample out the read out line-sampled out pixel samples for each even-numbered field or each odd-numbered field to produce a 1920×1080/50I-60I signal and store the produced 1920×1080/50I-60I signals into the RAMs 27-1 to 27-16.

The word sampling out control sections 28-1 to 28-16 sample out pixel samples sampled out for each field for each word. At this time, the word sampling out control sections 28-1 to 28-16 convert the 1920×1080/50I-60I/4:4:4, 4:2:2, 4:2:0/10-bit, 12-bit signals into 32 HD-SDIs. Then, the resulting pixel samples are mapped to the active period of eight HD-SDIs prescribed in the SMPTE 435-2 for each of the first to fourth sub images.

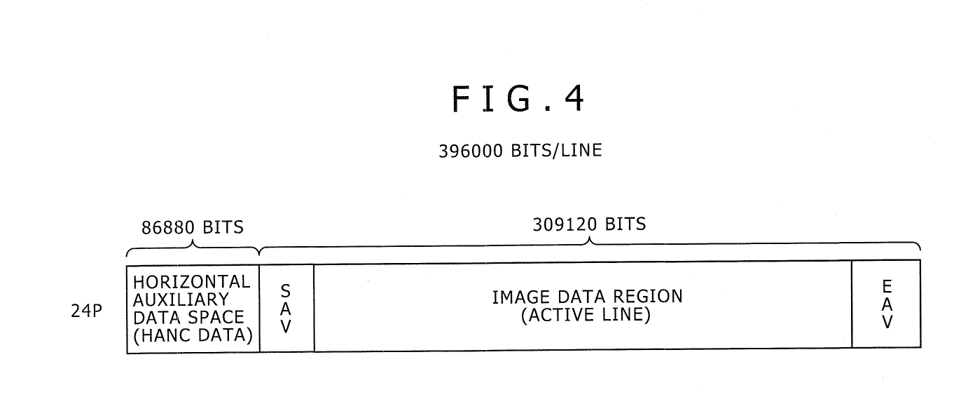

More particularly, the word sampling out control sections 28-1 to 28-16 read out pixel samples from the RAMs 25-1 to 25-16, respectively, by sampling out the pixel samples for each word by a method same as that of FIGS. 4, 6, 7, 8 and 9 of the SMPTE 372. Then, the word sampling out control sections 28-1 to 28-16 convert the read out pixel samples individually into 1920×1080/50I-60I signals of two channels and store the signals into the RAMs 29-1 to 29-32.

Thereafter, the readout control sections 30-1 to 30-32 output the HD-SDIs of the mode B read out from the RAMs 29-1 to 29-32, respectively.

In particular, the readout control section 30-1 to 30-32 read out pixel samples from the RAMs 29-1 to 29-32, respectively, in response to a reference clock supplied thereto from the clock supplying circuit 20. Then, the HD-SDIs 1 to 32 of 32 channels formed from 16 pairs of two links A and B are outputted to an S/P, scramble and 8B/10B section 12 at the succeeding stage.

It is to be noted that, in the present example, in order to carry out two-pixel sampling out, line sampling out, field sampling out and word sampling out, four kinds of memories, that is, the RAMs 23-1 to 23-4, RAMs 25-1 to 25-8, RAMs 27-1 to 27-16 and RAMs 29-1 to 29-32, are used. However, a single memory may be used to carry out line sampling out, field sampling out and word sampling out of data obtained by two-pixel sampling out so that the data are outputted as HD-SDIs of 32 channels.

Here, an example of a configuration of serial data of 10.692 Gbps prescribed by the HD-SDI format for one line is described with reference to FIG. 4.

FIG. 4 illustrates an example of a data structure for one line of serial digital data of 10.692 Gbps in the case of 24P.

In FIG. 4, serial digital data including a line number LN and error correction codes CRC are indicated as SAV, active line and EAV, and serial digital data including a region for additional data are indicated as horizontal auxiliary data space.

Then, in the horizontal auxiliary data space, an audio signal is mapped. Complementary data are added to the audio signal to configure the horizontal auxiliary data space to establish synchronism with the HD-SDI signal inputted.

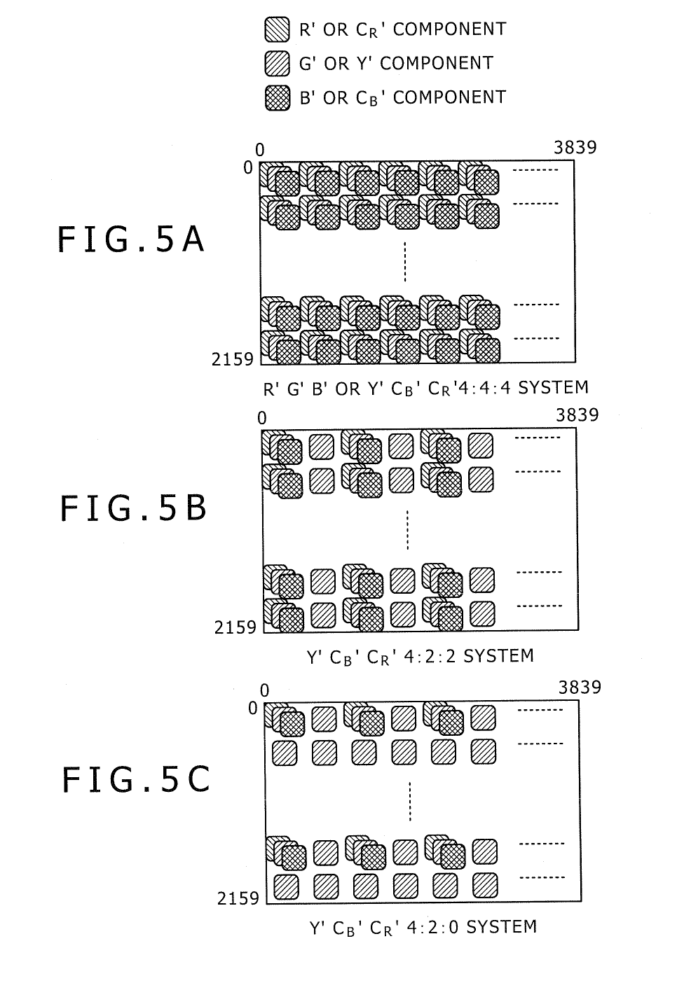

FIGS. 5A to 5C illustrate an example of a sample structure of the signal standard for 3840 samples×2160 lines. As a frame used in the description with reference to FIGS. 5A to 5C, one frame is configured from 3840 samples×2160 lines. Such one frame is hereinafter referred to also as one frame of a 4k×2k signal.

According to the signal standard for 3840 samples×2160 lines, three sample structures described below are available. It is to be noted that, in the SMPTE standard, a signal having a dash “′” applied thereto like R′, G′ or B′ represents a signal to which gamma correction is applied.

FIG. 5A illustrates an example of the sample structure of the R′G′B′, Y′Cb′Cr′ 4:4:4 system. In this system, RGB or YCbCr components are included in all samples.

FIG. 5B illustrates an example of the sample structure of the Y′Cb′Cr′ 4:2:2 system. In this system, YCbCr components are included in even-numbered samples, and a component of Y is included in odd-numbered samples.

FIG. 5C illustrates an example of the sample structure of the Y′Cb′Cr′ 4:2:0 system. In this system, YCbCr components are included in even-numbered samples, and a component of Y is included in odd-numbered samples. Further, the components from which CbCr components are sampled out are included in odd-numbered rows.

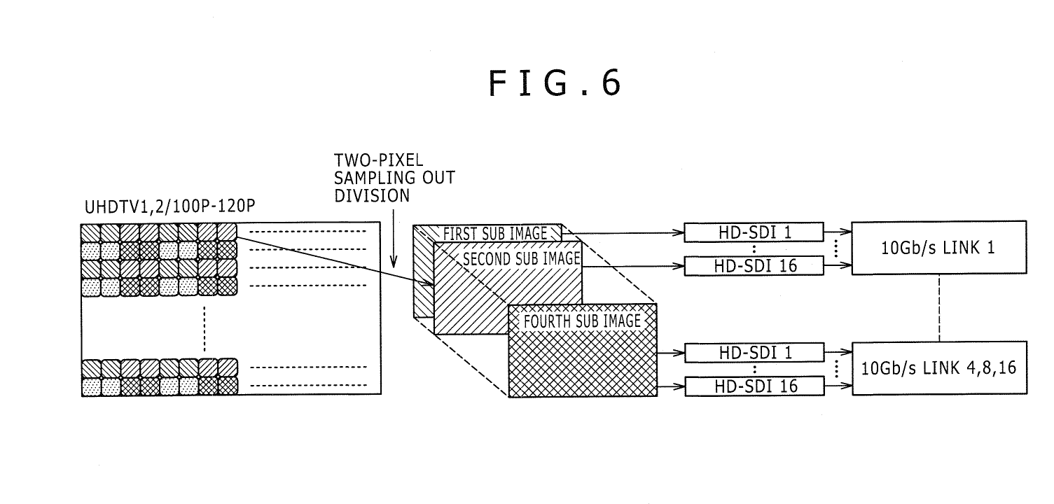

FIG. 6 illustrates an example of processing executed by the mapping section 11 to map pixel samples.

First, the mapping section 11 samples out a 3840×2160/100P-120P/4:4:4, 4:2:2, 4:2:0/10-bit, 12-bit signal for one frame or one screen image for every two pixels in a line direction. Then, sampled out signals are mapped to 1920 samples within the active period of the HD image format to produce first to fourth sub images.

At this time, the two-pixel sampling out control section 21 maps the signals sampled out for every two pixels to 1920×1080/100P-120P/4:4:4, 4:2:2, 4:2:0/10-bit, 12-bit signals of four channels. Here, each of the 1920×1080/100P-120P/4:4:4, 4:2:2, 4:2:0/10-bit, 12-bit signals is referred to as “sub image.” In the present example, the signals sampled out for every two pixels are mapped to the first to fourth sub images.

Then, the line sampling out control sections 24-1 to 24-4, field sampling out control sections 26-1 to 26-8 and word sampling out control sections 28-1 to 28-16 produce 1920×1080/23.98P-30P/4:2:2/10-bit signals of 32 channels. Then, the readout control section 30-1 to 30-32 output the produced signals as HD-SDIs 1 to 32.

Now, an example of detailed processing of a step carried out by the mapping section 11 to map pixel samples is described.

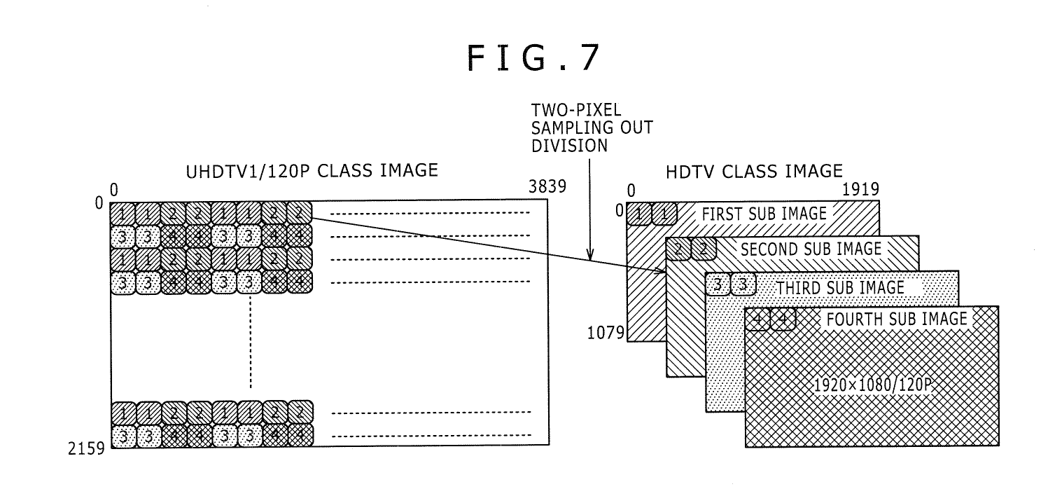

FIG. 7 illustrates an example of processing of sampling out pixel samples two by two pixels to map them to sub images.

The mapping process here is carried out under the control of the two-pixel sampling out control section 21 provided in the mapping section 11. The two-pixel sampling out control section 21 samples out a 3840×2160/100P-120P/4:4:4, 4:2:2, 4:2:0/10-bit, 12-bit signal for every two pixel samples in a line direction to multiplex the pixels in the active period of HD-SDIs. At this time, the two-pixel sampling out control section 21 maps the pixel samples to 1920×1080/100P-120P/4:4:4, 4:2:2, 4:2:0/10 bits, 12 bits of four channels, that is, to first to fourth sub images. The 1920×1080/100P-120P/4:4:4, 4:2:2, 4:2:0/10-bit, 12-bit signal has a frame rate equal to twice the frame rate of 1920×1080/50P-60P/4:4:4, 4:2:2/10-bit, 12-bit signals. The 1920×1080/50P-60P/4:4:4, 4:2:2/10-bit, 12-bit signal is prescribed by the SMPTE 274M and is same in terms of the digital signal form regarding an inhibition code and so forth.

Here, the mapping section 11 allocates 200h (10-bit system) or 800h (10-bit system), which are default values of the C channel, to 0 of 4:2:0 to treat a signal of 4:2:0 as a signal equivalent to a signal of 4:2:2. Then, the first to fourth sub images are stored into the RAMs 23-1 to 23-4, respectively.

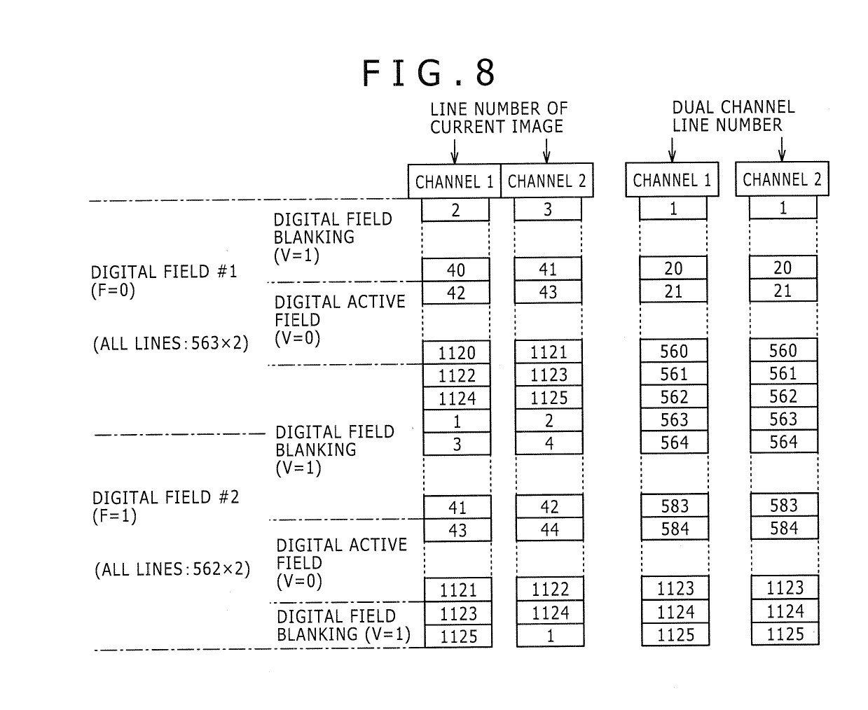

FIG. 8 illustrates an example of processing of sampling out pixel samples for each line to produce an interlace signal.

The line sampling out control sections 24-1 to 24-4 sample out the 1920×1080/100P-120P signals which form the first to fourth sub images for each line by a method same as that of FIG. 2 of the SMPTE 372. Then, the line sampling out control sections 24-1 to 24-4 convert the 1920×1080/100P-120P signals into 1920×1080/100I-120I signals of two channels. The 1920×1080/100I-120I/4:4:4, 4:2:2, 4:2:0/10-bit, 12-bit signals have a field rate equal to twice that of the 1920×1080/50I-60I (50I, 59.94I, 60I)/4:4:4, 4:2:2/10-bit, 12-bit signals. It is to be noted that the digital signal form regarding an inhibition code and so forth is same. Here, the 1920×1080/50I-60I (50I, 59.94I, 60I)/4:4:4, 4:2:2/10-bit, 12-bit signal is a signal defined by the SMPTE 274M.

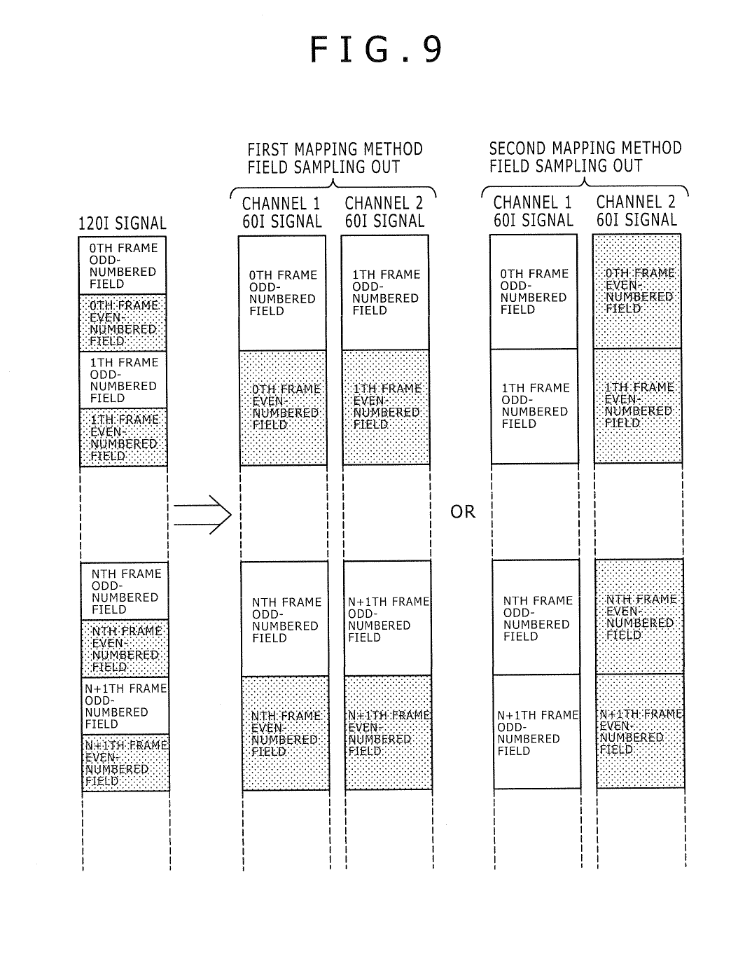

FIG. 9 illustrates an example of processing of sampling out pixel samples for each field to produce interlace signals of two channels.

On the left side in FIGS. 9, a 1920×1080/100I-120I signal is illustrated for each frame and each field.

The field sampling out control sections 26-1 to 26-8 read out 1920×1080/100I-120I signals from the RAMs 25-1 to 25-8 for each field and map them to two channels 1 and 2. Here, upon such mapping, the first or second mapping method described below is adopted.

### <First Mapping Method>

In the first mapping method, the field sampling out control sections 26-1 to 26-8 apply, to the two channels having a frame rate equal to one half that of the image signal, pixel samples where an odd-numbered field and an even-numbered field of the image signal are sampled out alternately. More particularly, the field sampling out control sections 26-1 to 26-8 map odd-numbered fields and even-numbered fields of even-numbered frames to the channel 1. Meanwhile, odd-numbered fields and even-numbered fields of odd-numbered frames are mapped to the channel 2.

### <Second Mapping Method>

In the second mapping method, the field sampling out control sections 26-1 to 26-8 map, to the channel 1 from between the channels 1 and 2 having a frame rate equal to one half that of an image signal, pixel samples included in odd-numbered fields of the image signal. Meanwhile, to the channel 2, pixel samples included in even-numbered fields of the image signal are mapped. More particularly, the field sampling out control sections 26-1 to 26-8 map odd-numbered fields of all frames to the channel 1. Meanwhile, the field sampling out control sections 26-1 to 26-8 map even-numbered fields of all frames to the channel 2.

Thereafter, the word sampling out control sections 28-1 to 28-16 map the channels 1 and 2 including the 1920×1080/100I-120I signals mapped thereto by the first or second mapping method to the Links A and B in the following manner.

In the case of 4:4:4, the word sampling out control sections 28-1 to 28-16 carry out mapping of the channels 1 and 2 to the Links A and B, that is, to HD-SDIs of two channels, by the method of FIG. 4 (10 bits) or FIG. 6 (12 bits) of the S372.

In the case of 4:2:2, the word sampling out control sections 28-1 to 28-16 do not use the Link B and use only the channels CH1, CH3, CH5 and CH7.

The first to fourth sub images are mapped to the HD-SDIs of eight channels to produce HD-SDIs of 32 channels in this manner. Then, the readout control sections 30-1 to 30-32 multiplex and transmit the 1920×1080/100I-120I/4:4:4, 4:2:2, 4:2:0/10-bit, 12-bit signals with 10.692 Gbps of four channels prescribed by the mode D.

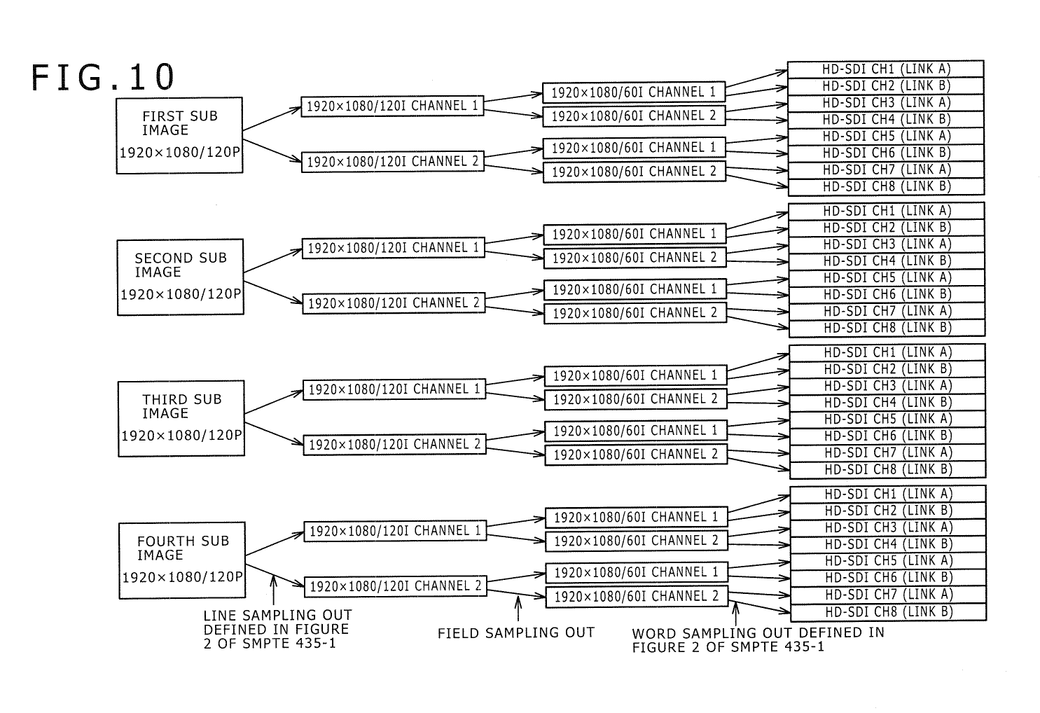

FIG. 10 illustrates an example of the channel numbers when line sampling out, field sampling out and word sampling out are carried out.

First, first to fourth sub images, that is, 1920×1080/100P-120P/4:4:4, 4:2:2, 4:2:0/10-bit, 12-bit signals, to which pixel samples are mapped, are subjected to line sampling out. This line sampling out is carried out by the method defined by FIG. 2 of the SMPTE 435-1. As a result of the line sampling out of the first to fourth sub images, the total channel number increases to eight.

Then, the 1920×1080/100I-120I/4:4:4, 4:2:2, 4:2:0/10-bit, 12-bit signals are subjected to field sampling out. As a result of the field sampling out of the 1920×1080/100I-120I/4:4:4, 4:2:2, 4:2:0/10-bit, 12-bit signal, the total channel number increases to 16.

Then, the 1920×1080/50I-60I/4:4:4, 4:2:2, 4:2:0/10-bit, 12-bit signals are subjected to word sampling out by the method defined by FIG. 2 of the SMPTE 435-1. As a result of the word sampling out, the total channel number increases to 32. At this time, the 1920×1080/50I-60I/4:4:4, 4:2:2/10-bit, 12-bit signals are mapped divisionally to the links A and B of HD-SDIs in accordance with the provision of the SMPTE 372M.

Here, the following first or second sampling out process may be carried out similarly to the sampling out processes carried out by the mapping section 11 of the present example, that is, the two-pixel sampling out, line sampling out, field sampling out and word sampling out processes. In the following, the effectiveness of the first or second sampling out process is studied. Also a 7680×4320/100P-120P signal is studied here in addition to a 3840×2160/100P-120P signal.
(1) In the first sampling out process, a 3840×2160/100P-120P/4:4:4, 4:2:2, 4:2:0/10-bit, 12-bit signal is first subjected to line sampling out by the method described hereinabove with reference to FIG. 8 to produce a 3840×2160/100I-120I signal. Then, the 3840×2160/100I-120I signal is subjected to field sampling out by the method described hereinabove with reference to FIG. 9 and finally mapped to HD-SDIs of 32 channels by the method described hereinabove with reference to FIG. 10.
(2) In the second sampling out process, a 3840×2160/100P-120P/4:4:4, 4:2:2, 4:2:0/10-bit, 12-bit signal is first subjected to frame sampling out to map the same to 3840×2160/50P-60P signals of two channels. Thereafter, the 3840×2160/50P-60P signals are subjected to two-pixel sampling out to map the 1920×1080/50P-60P signals to eight channels similarly as in the S2036-3. Finally, the 1920×1080/50P-60P signals are individually mapped to HD-SDIs of four channels to produce HD-SDIs of 32 channels.

However, the memory capacity in the mapping processes is determined in the following manner.
(a) The memory capacity necessary for mapping two-pixel samples is several bytes.
(b) The memory capacity necessary for storing a 1920×1080/10-bit signal for a one-line period is 1920 samples×20 bits 8 bits=4.8 kilobytes.

Meanwhile, the memory capacity necessary within a one-line period of a 3840×2160/100P-120P/10-bit signal is equal to twice that given above, that is, 9.6 kilobytes. Further, the memory capacity necessary for a one-line period of a 7680×4320/100P-120P/10-bit signal is equal to four times that given above, that is, 19.2 kilobytes.
(c) The memory capacity necessary for storing a 1920×1080/10-bit signal for an active period is 1920 samples×20 bits×1080 lines 8 bits=5.184 megabytes.

Therefore, the memory capacity necessary for storing a 1920×1080/10-bit interlace signal for an active field period is one half that given above, that is, 2.592 megabytes.

Similarly, the memory capacity necessary for storing a 3840×2160/10-bit signal for an active period is 20.736 megabytes equal to four times that given above (10.368 megabytes for the active field period). Further, the memory capacity necessary for a 7680×4320/10-bit signal for an active period is 16 times that given above, that is, 82.944 megabytes (41.472 megabytes for the active field period).

Here, the memory capacity necessitated by the transmission apparatus according to the present embodiment is approximately 2.6 megabytes corresponding to the field memory capacity for a 1920×1080/10-bit signal.

Further, in the first sampling out process, the necessitated memory capacity is approximately 10.4 megabytes corresponding to the field memory capacity for a 3840×2160 signal.

In the second sampling out process, the necessitated memory capacity is approximately 20.8 megabytes corresponding to the frame memory capacity for a 3840×2160 signal.

Therefore, the sampling out process carried out by the transmission apparatus according to the present embodiment is effective for reduction of the memory capacity.

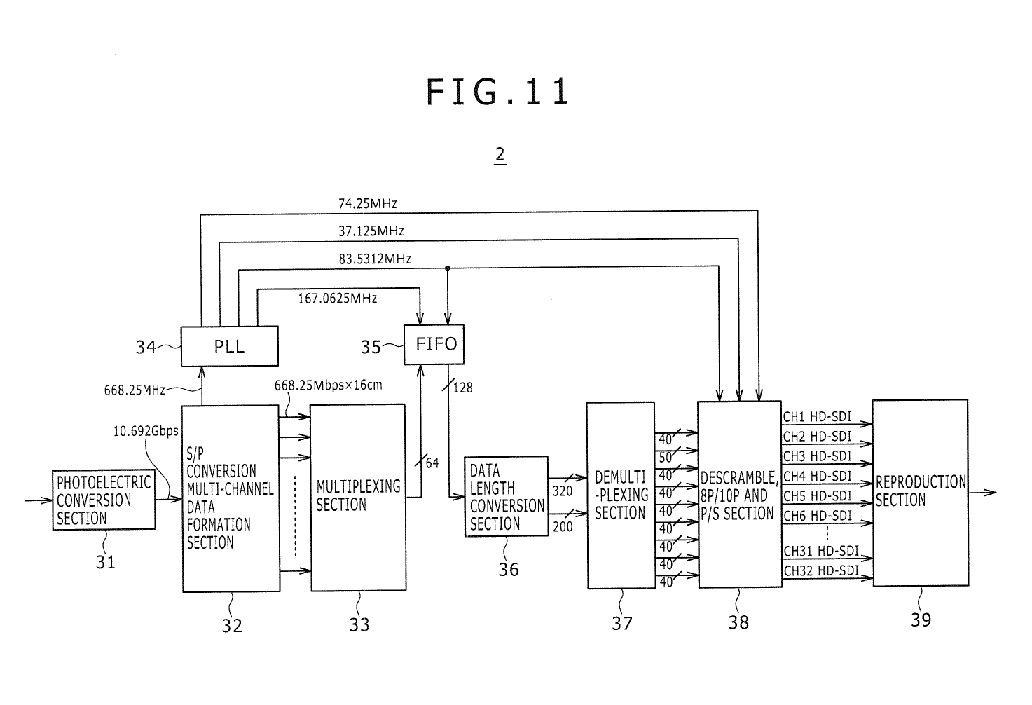

FIG. 11 shows part of the circuit configuration of the CCU 2 which relates to the present embodiment. The CCU 2 includes a plurality of such circuits which correspond in a one-by-one corresponding relationship to the broadcasting cameras 1.

Serial digital data of the bit rate of 10.692 Gbps transmitted from each broadcasting camera 1 through an optical fiber cable 3 is converted into an electric signal by a photoelectric conversion section 31 and then sent to an S/P conversion multi-channel data formation section 32. The S/P conversion multi-channel data formation section 32 is, for example, an XSBI described hereinabove. The S/P conversion multi-channel data formation section 32 receives the serial digital data of the bit rate of 10.692 Gbps with which HDD-SDIs of 32 channels are multiplexed in the mode D.

The S/P conversion multi-channel data formation section 32 carries out serial/parallel conversion of the serial digital data of the bit rate of 10.692 Gbps. Then, the S/P conversion multi-channel data formation section 32 forms serial digital data for 16 channels each having the bit rate of 668.25 Mbps and extracts a clock of 668.25 MHz from the parallel digital data obtained by the serial/parallel conversion.

The parallel digital data of 16 channels formed by the S/P conversion multi-channel data formation section 32 is sent to a multiplexing section 33. Meanwhile, the clock of 668.25 MHz extracted by the S/P conversion multi-channel data formation section 32 is sent to a PLL 34.

The multiplexing section 33 multiplexes the serial digital data of 16 channels from the S/P conversion multi-channel data formation section 32 to produce parallel digital data of the 64-bit width and sends the parallel digital data to a FIFO memory 35.

The PLL 34 divides the clock 668.25 MHz from the S/P conversion multi-channel data formation section 32 by four to produce a clock of 167.0625 MHz and sends the clock of 167.0625 MHz as a write clock to the FIFO memory 35.

Further, the PLL 34 divides the clock of 668.25 MHz from the S/P conversion multi-channel data formation section 32 by eight to produce a clock of 83.5312 MHz and sends the clock of 83.5312 MHz as a read clock to the FIFO memory 35. Further, the PLL 34 sends the clock of 83.5312 MHz as a write clock to a FIFO memory in a descramble, 8B/10B and P/S section 38.

Further, the PLL 34 divides the clock of 668.25 MHz from the S/P conversion multi-channel data formation section 32 by eighteen to produce a clock of 37.125 MHz and sends the clock of 37.125 MHz as a read clock to the FIFO memory in the descramble, 8B/10B and P/S section 38. Further, the PLL 34 sends the clock of 37.125 MHz as a write clock to the FIFO memory in the descramble, 8B/10B and P/S section 38.

Further, the PLL 34 divides the clock of 668.25 MHz from the S/P conversion multi-channel data formation section 32 by nine to produce a clock of 74.25 MHz and sends the clock of 74.25 MHz as a read clock to the FIFO memory in the descramble, 8B/10B and P/S section 38.

Into the FIFO memory 35, parallel digital data of the 64-bit width from the multiplexing section 33 is written in response to the clock of 167.0625 MHz from the PLL 34. The parallel digital data written in the FIFO memory 35 is read out as parallel digital data of the 128-bit width in response to the clock of 83.5312 MHz from the PLL 34 and sent to a data length conversion section 36.

The data length conversion section 36 is configured using a shift register and converts the parallel digital data of the 128-bit width into parallel digital data of the 256-bit width. Then, the data length conversion section 36 detects K28.5 inserted in the timing reference signal SAV or EAV. Thus, the data length conversion section 36 discriminates each line period to convert data of the timing reference signal SAV, active line, timing reference signal EAV, line number LN and error detection code CRC into data of the 320-bit width. Further, the data length conversion section 36 converts data of the horizontal auxiliary data space, that is, the data of the horizontal auxiliary data space of the channel CH1 obtained by the 8B/10B encoding, into data of the 200-bit width. The parallel digital data of the 320-bit width and the parallel digital data of the 200-bit width obtained by the data length conversion by the data length conversion section 36 are sent to a demultiplexing section 37.

The demultiplexing section 37 demultiplexes parallel digital data of the 320-bit width from the data length conversion section 36 into data of the channels CH1 to CH32 of 40 bits before they are multiplexed by the multiplexing section 14 (FIG. 2) in the broadcasting camera 1. The parallel digital data includes data of the timing reference signal SAV, active line, timing reference signal EAV, line number LN and error detection code CRC. Then, the parallel digital data of the 40-bit width of the channels CH1 to CH32 are sent to the descramble, 8B/10B and P/S section 38.

Further, the demultiplexing section 37 demultiplexes parallel digital data of the 200-bit width from the data length conversion section 36 into data of 50 bits before they are multiplexed by the multiplexing section 14. The parallel digital data includes data of the horizontal auxiliary data space of the channel CH1 in the form encoded by 8B/10B encoding. Then, the demultiplexing section 37 sends parallel digital data of the 50-bit width of the channels CH1 to CH32 to the descramble, 8B/10B and P/S section 38.

The descramble, 8B/10B and P/S section 38 is formed from 32 blocks corresponding in a one-by-one corresponding relationship to the channels CH1 to CH32. The descramble, 8B/10B and P/S section 38 in the present example functions as a reception section for receiving first, second, third and fourth sub images to which an image signal is mapped and each of which is divided into a first link channel and a second link channel.

The descramble, 8B/10B and P/S section 38 includes blocks for the channels CH1, CH3, CH5, CH7, . . . , CH31 of the Link A, and descrambles parallel digital data inputted thereto to convert them into serial digital data and outputs the serial digital data.

The descramble, 8B/10B and P/S section 38 further includes blocks for the channels CH2, CH4, CH6, CH8, . . . , CH32 of the Link B, and decodes parallel digital data inputted thereto by 8B/10B decoding. Then, the descramble, 8B/10B and P/S section 38 converts resulting data into serial digital data and outputs the serial digital data.

A reproduction section 39 carries out a process reverse to the process of the mapping section 11 in the broadcasting camera 1 in accordance with the SMPTE 435 for HD-SDI signals of the channels CH1 to CH32 (Link A and link B) sent thereto from the descramble, 8B/10B and P/S section 38. By this process, the reproduction section 39 reproduces a 3840×2160/100P-120P/4:4:4, 4:2:2, 4:2:0/10-bit, 12-bit signal.

At this time, the reproduction section 39 reproduces first, second, third and fourth sub images from the HD-SDIs 1 to 32 received by the S/P conversion multi-channel data formation section 32. At this time, the word multiplexing, field multiplexing and line multiplexing processes are carried out in order. Then, the reproduction section 39 extracts pixel samples disposed in the active period of the first, second, third and fourth sub images two by two pixels and multiplexes the extracted pixels in order into one frame of an image signal.

Then, the reproduction section 39 disposes the samples mapped to the first sub image and the second sub image alternately on an odd-numbered line. Similarly, the reproduction section 39 disposes samples mapped to the third sub image and the fourth sub image alternately on an even-numbered line. Then, the reproduction section 39 samples out, from samples disposed on each line, pixels adjacent the samples and multiplexes resulting pixels.

The 3840×2160/100P-120P/4:4:4, 4:2:2, 4:2:0/10-bit, 12-bit signal reproduced by the reproduction section 39 is outputted from the CCU 2 and sent, for example, to a VTR not shown.

In the present example, the CCU 2 carries out signal processing on the side which receives serial digital data produced by the broadcasting cameras 1. In the signal reception apparatus and the signal reception method, parallel digital data is produced from the serial digital data of the bit rate of 10.692 Gbps, and the parallel digital data is demultiplexed into data of the individual channels of the Link A and Link B.

The demultiplexed data of the Link A is subjected to self-synchronizing descrambling, and immediately prior to the timing reference signal SAV, all of the values of registers in a descrambler are set to 0 to start decoding. Further, self-synchronizing descrambling is applied also to data of at least several bits following the error detection code CRC. Consequently, self-synchronizing scrambling is applied only to data of the timing reference signal SAV, active line, timing reference signal EAV, line number LN and error detection code CRC. Therefore, although the data of the horizontal auxiliary data space is not subject to self-synchronizing scrambling, it is possible to carry out accurate calculation taking carry of the descrambler as a multiplication circuit into consideration to reproduce original data.

Meanwhile, as regards the demultiplexed data of the Link B, sample data of the Link B are formed from the bits of RGB obtained by 8 bits/10 bits decoding. Then, the parallel digital data of the Link A to which the self-synchronizing descrambling is applied and the parallel digital data of the Link B from which the samples are formed are individually subjected to parallel/serial conversion. Then, mapped HD-SDI signals of the channels CH1 to CH32 are reproduced.

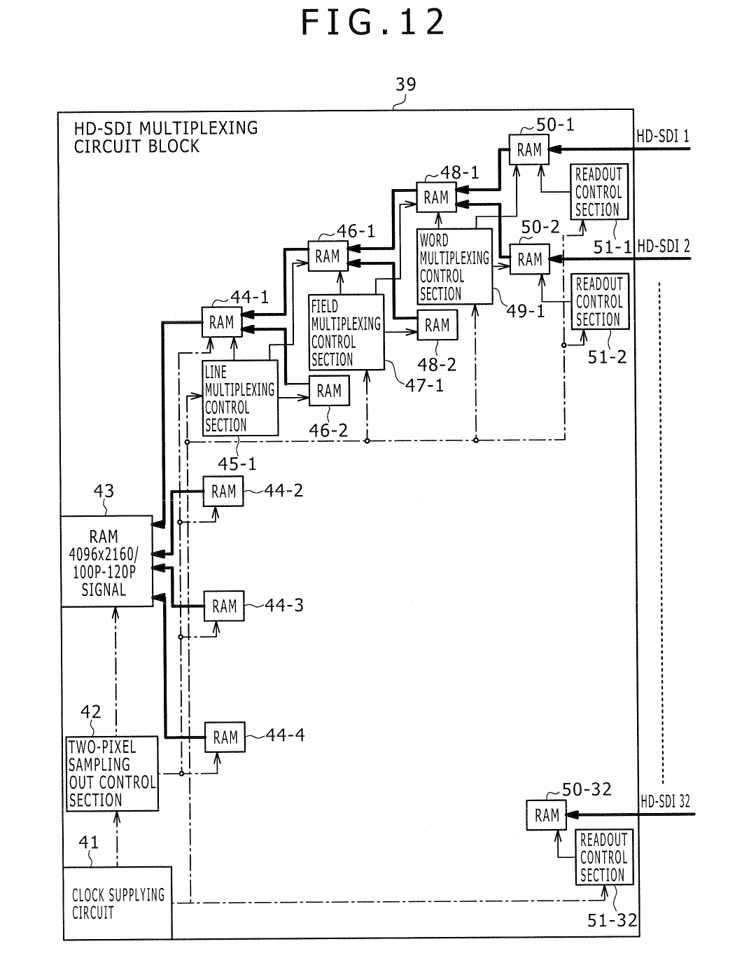

FIG. 12 shows an example of an internal configuration of the reproduction section 39.

The reproduction section 39 is a block for carrying out reverse conversion to the process carried out for pixel samples by the mapping section 11.

The reproduction section 39 includes a clock supplying circuit 41 for supplying clocks to associated blocks. The reproduction section 39 further includes RAMs 50-1 to 50-32 for storing 32 HD-SDIs 1 to 32 of the mode D prescribed by the SMPTE 435-2, respectively. The HD-SDIs 1 to 32 configure 1920×1080/50I-60I signals. For the HD-SDIs 1 to 32, the channels CH1, CH3, CH5, CH7, . . . , CH31 of the link A inputted from the descramble, 8B/10B and P/S section 38 and channels CH2, CH4, CH6, CH8, . . . , CH32 of the Link B of the descramble, 8B/10B and P/S section 38 are used.

Write control sections 51-1 to 51-32 carry out control to store the 32 HD-SDIs 1 to 32 prescribed by the SMPTE 435-2 and inputted thereto into the RAMs 50-1 to 50-32 in response to a clock supplied thereto from the clock supplying circuit 41.

The reproduction section 39 further includes word multiplexing control sections 49-1 to 49-16 for controlling word multiplexing or deinterleave, and RAMs 48-1 to 48-16 into which data temporarily multiplexed by the word multiplexing control sections 49-1 to 49-16 are written.

The word multiplexing control sections 49-1 to 49-16 multiplex pixel samples extracted from within the active period of the HD-SDIs read out from the RAMs 50-1 to 50-32 for each word of reverse conversion of the FIGS. 4, 6, 7, 8 and 9 of the SMPTE 372. In particular, the word multiplexing control sections 49-1 to 49-16 control the timing for each of the RAMs 50-1 and 50-2, the RAMs 50-3 and 50-4, . . . , and the RAMs 50-31 and 50-32 thereby multiplexing the pixel sample. Then, the word multiplexing control sections 49-1 to 49-16 produce and store 1920×1080/50I-60I/4:4:4, 4:2:2, 4:2:0/10-bit, 12-bit signals into the RAMs 48-1 to 48-16.

The field multiplexing control sections 47-1 to 47-8 multiplex pixel samples read out from the RAMs 50-1 to 50-32 for each field. Then, the field multiplexing control sections 47-1 to 47-8 produce and store 1920×1080/100I-120I/4:4:4, 4:2:2, 4:2:0/10-bit, 12-bit signals into the RAMS 46-1 to 46-8.

Here, the field multiplexing control sections 47-1 to 47-8 use one of the following mapping methods to carry out field multiplexing of pixel samples.

### <First Multiplexing Method>

The field multiplexing control sections 47-1 to 47-8 multiplex the pixel samples into the first and second channels wherein the frame rate of the pixel samples multiplexed by the RAMs 48-1 to 48-16 is twice that of HD-SDIs. At this time, pixel samples of each odd-numbered field included in the first and second channels are multiplexed alternately in the odd-numbered field of one channel whose frame rate is twice that of HD-SDIs. Further, pixel samples of each even-numbered field included in the first and second channels are multiplexed alternately with the even-numbered field of one channel whose frame rate is twice that of HD-SDIs.

### <Second Multiplexing Method>

The field multiplexing control sections 47-1 to 47-8 multiplex the pixel samples into the first and second channels wherein the frame rate of the pixel samples multiplexed by the RAMs 48-1 to 48-16 is twice that of HD-SDIs. At this time, the pixel samples included in the first channel are multiplexed into odd-numbered fields of one channel wherein the frame rate is twice that of HD-SDIs. Further, the pixel samples included in the second channel are multiplexed into even-numbered fields of one channel wherein the frame rate is twice that of HD-SDIs.

It is to be noted that the field multiplexing by the first or second multiplexing method described above is a process of reverse conversion to that of the first or second mapping method used in the field sampling out described hereinabove with reference to FIG. 9.

The line multiplexing control sections 45-1 to 45-4 multiplex pixel samples read out from the RAMs 46-1 to 46-8 and multiplexed for each field for each line to produce a progressive signal. Then, the line multiplexing control sections 45-1 to 45-4 produce and store 1920×1080/100P-120P/4:4:4, 4:2:2, 4:2:0/10-bit, 12-bit signals into the RAMs 44-1 to 44-4, respectively. The signals configure first to fourth sub images.

The two-pixel multiplexing control section 42 multiplexes pixel samples read out from the RAMs 44-1 to 44-4 by the following process for each two pixels. In particular, pixel samples extracted two by two pixels from the first sub image and the second sub image are multiplexed in conformity with a class image of the UHDTV1. This class image is a 3840×2160/100P, 119.88P, 120P/4:4:4, 4:2:2, 4:2:0/10-bit, 12-bit signal. Then, the two-pixel multiplexing control section 42 multiplexes the pixel samples in an adjacent relationship to each other on an odd-numbered line of a frame defined by the image signal. Similarly, the two-pixel multiplexing control section 42 multiplexes the pixel samples extracted two by two pixels from the third sub image and fourth sub image in an adjacent relationship to each other on an even-numbered line of a frame defined by the image signal. Then, the 3840×2160/100P-120P signal is stored into the RAM 43 and is reproduced suitably.

The clock supplying circuit 41 supplies a clock to the two-pixel multiplexing control section 42, line multiplexing control sections 45-1 to 45-4, field multiplexing control sections 47-1 to 47-8, word multiplexing control sections 49-1 to 49-16 and write control sections 51-1 to 51-32. The blocks mentioned are synchronized with each other by the clock so that reading out or writing of pixel samples is controlled.

It is to be noted that FIG. 12 illustrates an example wherein two-pixel multiplexing, line multiplexing, field multiplex and word multiplexing are carried out at four different stages using four different kinds of RAMs. However, alternatively a single RAM may be used to reproduce a 3840×2160/100P-120P/4:4:4, 4:2:2, 4:2:0/10-bit, 12-bit signal.

With the transmission system 10 of the first embodiment described above, the sampling out process according to the present embodiment is carried out. In particular, a 3840×2160 signal having a great pixel number is sampled out in a unit of two pixel samples so as to be mapped to a plurality of 1920×1080 signals, and then line sampling out and field sampling out are carried out. This sampling out processing minimizes the memory capacity necessary to map a signal and can suppress also the transmission delay of signals to a minimum level because the memory capacity is minimized.

Further, by sampling out a 4k, 8k signal for each two pixel samples, the video of the entire screen can be observed using an existing monitor for the HD or a waveform monitor or an 8k signal can be observed using a future 4k monitor or the like. Therefore, the transmission system 10 is effective for analysis of a fault when a video apparatus is developed and so forth.

### 2. Second Embodiment (UHDTV2 7680×4320/100P, 119.88, 120P/4:4:4, 4:2:2, 4:2:0/10 Bits, 12 Bits

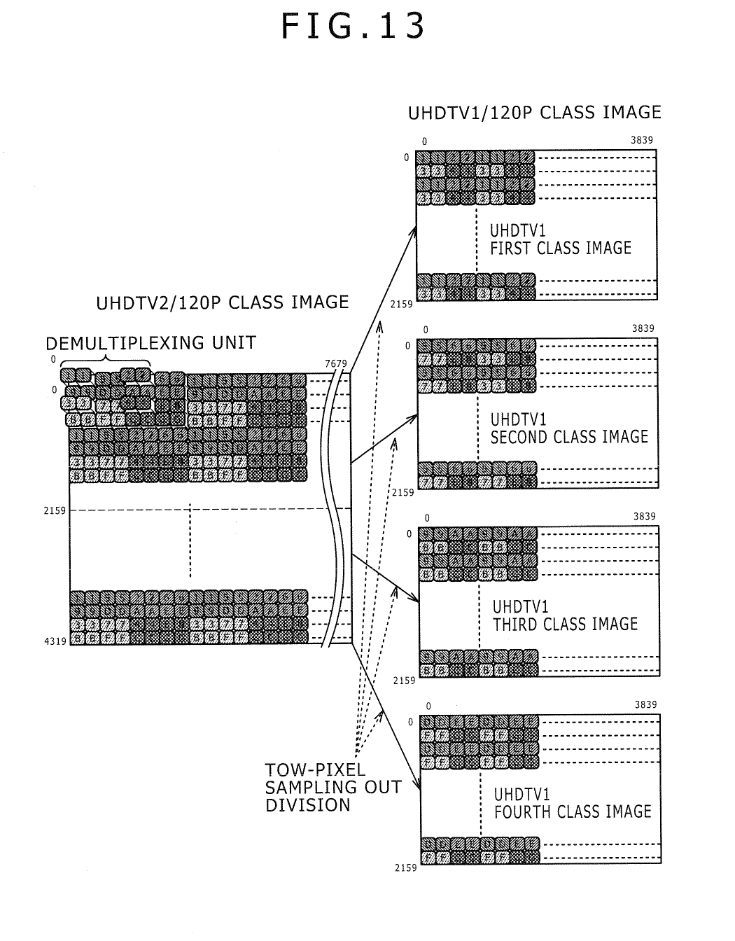

Now, an example of operation of the mapping section 11 and the reproduction section 39 according to the second embodiment of the present invention is described with reference to FIGS. 13 to 15.

Here, a method of sampling out pixel samples of a 7680×4320/100P-120P/4:4:4, 4:2:2, 4:2:0/10-bit, 12-bit signal is described.

FIG. 13 illustrates processing by the mapping section 11 when it maps pixel samples.

In the present example, a 7680×4320/100P-120P/4:4:4, 4:2:2, 4:2:0/10-bit, 12-bit signal prescribed by the UHDTV2 is inputted to the mapping section 11. The 7680×4320/100P-120P/4:4:4, 4:2:2, 4:2:0/10-bit, 12-bit signal has a frame rate equal to twice that of a signal prescribed by the S2036-1. The signal prescribed by the S2036-1 is a 7680×4320/50P-60P/4:4:4, 4:2:2, 4:2:0/10-bit, 12-bit signal. Further, the 7680×4320/100P-120P signal and the 7680×4320/50P-60P signal are same in the digital signal form of an inhibition code and so forth.

Then, the 7680×4320/100P-120P/4:4:4, 4:2:2, 4:2:0/10-bit, 12-bit signal is mapped to a class image prescribed by the UHDTV1. This class image is a 3840×2160/100P-120P/4:4:4, 4:2:2, 4:2:0/10-bit, 12-bit signal.

At this time, the 7680×4320/100P-120P/4:4:4, 4:2:2, 4:2:0/10-bit, 12-bit signal is sampled out for every two pixel samples in a line direction. Then, the pixel samples are mapped to 3840×2160/100P-120P/4:4:4, 4:2:2, 4:2:0/10-bit, 12-bit signals of four channels. The 3840×2160/100P-120P/4:4:4, 4:2:2, 4:2:0/10-bit, 12-bit signals of four channels can be transmitted in the mode D of 10.692 Gbps of four channels by such a method as described hereinabove in connection with the first embodiment. Therefore, the signals mentioned can be transmitted in the mode D of 10.692 Gbps of totaling 16 channels.

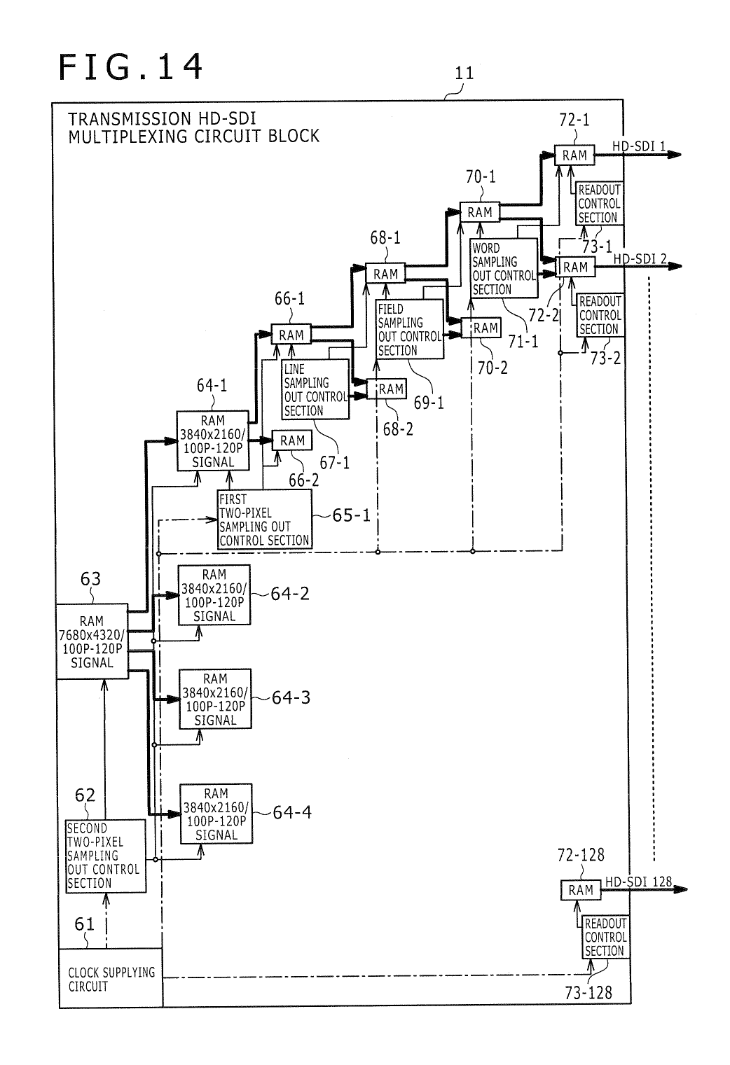

FIG. 14 shows an example of an internal configuration of the mapping section 11.

Referring to FIG. 14, the mapping section 11 includes a clock supplying circuit 61 for supplying a clock to components of the mapping section 11, and a RAM 63 for storing a 7680×4320/100P-120P video signal. Further, the mapping section 11 includes a two-pixel sampling out (interleave) control section 62 for controlling two-pixel sampling out (interleave) for reading out pixel samples two by two pixels from within the 7680×4320/100P-120P video signal stored in the RAM 63. The pixel samples after the two-pixel sampling out are stored as first to fourth class images of the 3840×2160/100P-120P/4:4:4, 4:2:2, 4:2:0/10-bit, 12-bit signal prescribed by the UHDTV1 into RAMs 64-1 to 64-4.

The mapping section 11 includes first two-pixel sampling out control sections 65-1 to 65-4 for controlling two-pixel sampling out of reading out pixel samples two by to pixels from the first to fourth sub class images read out from the RAMs 64-1 to 64-4, respectively. The operation of the first two-pixel sampling out control sections 65-1 to 65-4 when they map pixel samples to the sub images is similar to the operation of the two-pixel sampling out control section 21 according to the first embodiment described hereinabove. The pixel samples obtained by the two-pixel sampling are stored as first to fourth sub images into RAMs 66-1 to 66-16.

The mapping section 11 further includes line sampling out control sections 67-1 to 67-16 for carrying out line sampling out of data read out from the RAMs 66-1 to 66-16, and RAMs 68-1 to 68-32 into which data temporarily sampled out by the line sampling out control sections 67-1 to 67-16 are written.

The mapping section 11 further includes field sampling out control sections 69-1 to 69-32 for controlling field sampling out of data read out from the RAMs 68-1 to 68-32. The mapping section 11 further includes RAMs 70-1 to 70-64 into which data temporarily sampled out by the field sampling out control sections 69-1 to 69-32 are written.

The mapping section 11 further includes word sampling out control section 71-1 to 71-64 for controlling word sampling out of data read out from the RAMs 70-1 to 70-64. The mapping section 11 further includes RAMs 72-1 to 72-128 into which data temporarily sampled out by the word sampling out control sections 71-1 to 71-64 are written.

The mapping section 11 further includes readout control sections 73-1 to 73-128 for outputting pixel samples of data read out from the RAMs 72-1 to 72-128 as HD-SDIs of 32 channels.

It is to be noted that, while FIG. 14 illustrates those blocks for producing the HD-SDI 1, also the blocks for producing the HD-SDIs 2 to 128 have a similar configuration, and therefore, illustration and overlapping detailed description of the blocks are omitted.

The clock supplying circuit 61 supplies a clock to the second two-pixel sampling out control section 62, line sampling out control sections 67-1 to 67-16, field sampling out control sections 69-1 to 69-32, word sampling out control sections 71-1 to 71-64 and readout control sections 73-1 to 73-128. This clock is used for reading out or writing of pixel samples, and the blocks mentioned are synchronized with each other by the clock.

A class image defined by a 7680×4320/100P, 119.88P, 120P/4:4:4, 4:2:2, 4:2:0/10-bit, 12-bit signal inputted from an image sensor not shown is stored into the RAM 63. The second two-pixel sampling out control section 62 samples out two pixel samples adjacent each other on the same line by a method prescribed by the SMPTE 435-1 from among pixel samples extracted from each frame defined by the class image prescribed by the UHDTV2. At this time, the first two-pixel sampling out control section 62 alternately samples out pixel samples on each odd-numbered line of the class image prescribed by the UHDTV2 and maps them to a first class image and a second class image prescribed by the UHDTV1. Similarly, the second two-pixel sampling out control section 62 alternately samples out pixel samples on each even-numbered line of the class image prescribed by the UHDTV2 and maps them to a third class image and a fourth class image prescribed by the UHDTV 1.

Further, the first two-pixel sampling out control sections 65-1 to 65-4 alternately sample out the pixel samples on each odd-numbered line of each frame of the first to fourth class images prescribed by the UDHTV1 to the first sub image and the second sub image. Similarly, the second two-pixel sampling out control section 62 alternately samples out the pixel samples on each even-numbered line of each frame to the third sub image and the fourth sub image. Later processing is carried out similarly as in the sampling out processing in the first embodiment described hereinabove.

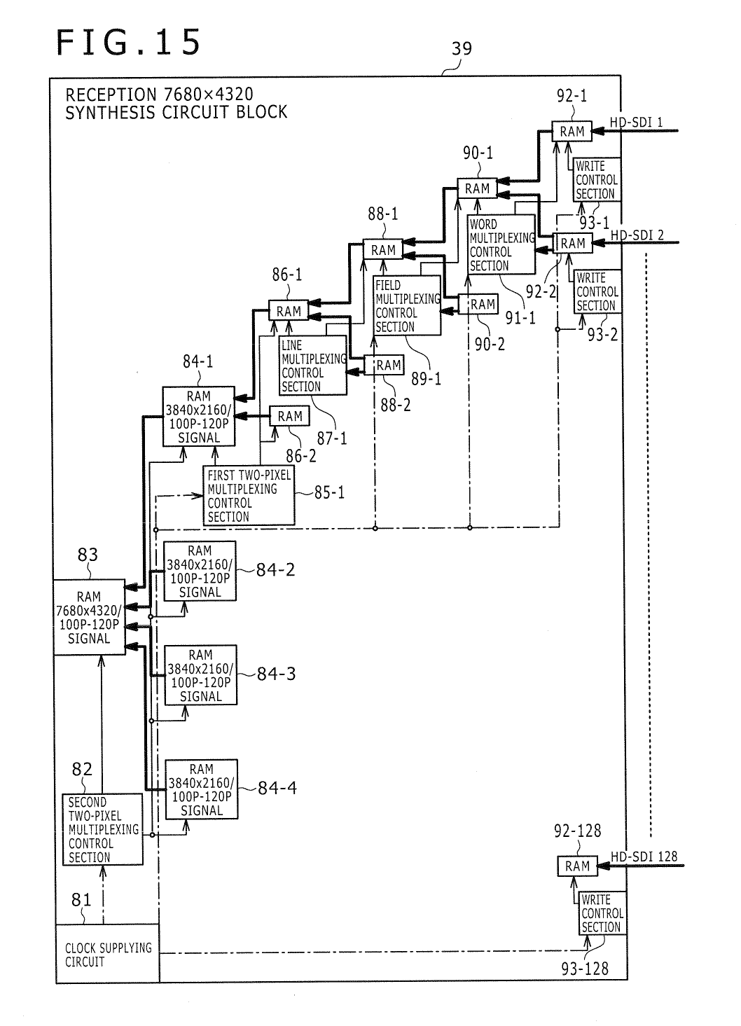

FIG. 15 shows an example of an internal configuration of the reproduction section 39.

The reproduction section 39 is a block for reverse conversion to that of the process carried out by the mapping section 11 for pixel samples.

Referring to FIG. 15, the reproduction section 39 includes a clock supplying circuit 81 for supplying a clock to the components of the reproduction section 39. The reproduction section 39 further includes RAMs 92-1 to 92-128 for storing 128 HD-SDIs 1 to 128 which configure 1920×1080/50I-60I signals, respectively. For the HD-SDIs 1 to 128, the channels CH1, CH3, CH5, CH7, . . . , CH127 of the Link A and the channels CH2, CH4, CH6, CH8, . . . , CH128 of the link B inputted from the descramble, 8B/10B and P/S section 38 are used. Write control sections 93-1 to 93-128 carry out control to carry out the 128 HD-SDIs 1 to 128 prescribed by the SMPTE 435-2 and inputted thereto into the RAMs 92-1 to 92-128 in response to a clock supplied thereto from the clock supplying circuit 81.

The reproduction section 39 further includes word multiplexing control sections 91-1 to 91-64 for controlling word multiplexing or deinterleave, and RAMs 90-1 to 90-64 into which the data temporarily multiplexed by the word multiplexing control sections 91-1 to 91-64 are written.

The word multiplexing control sections 91-1 to 91-64 multiplex pixel samples extracted from within the active period of the HD-SDIs read out from the RAMs 92-1 to 92-128 for each word of the reverse conversion of FIGS. 4, 6, 7, 8 and 9 of the SMPTE 372. In particular, the word multiplexing control sections 91-1 to 91-64 control the timing for each of the RAMs 92-1 and 92-2, RAMs 92-3 and 92-4, . . . , RAMs 92-127 and 92-128 to multiplex the pixel samples. Then, the word multiplexing control sections 91-1 to 91-64 produce 1920×1080/50I-60I/4:4:4, 4:2:2, 4:2:0/10-bit, 12-bit signals and store them into the RAMs 90-1 to 90-64.

Field multiplexing control sections 89-1 to 89-32 multiplex pixel samples read out from the RAMs 90-1 to 90-64 for each field. Then, the field multiplexing control sections 89-1 to 89-32 produce 1920×1080/100I-120I/4:4:4, 4:2:2, 4:2:0/10-bit, 12-bit signals and store them into RAMs 88-1 to 88-32.

Line multiplexing control sections 87-1 to 87-16 multiplex pixel samples read out from the RAMs 88-1 to 88-32 for each line. Then, the line multiplexing control sections 87-1 to 87-16 produce 1920×1080/100P-120P/4:4:4, 4:2:2, 4:2:0/10-bit, 12-bit signals and store them into RAMs 86-1 to 86-16. The signals configure first to fourth sub images.

First two-pixel multiplexing control sections 85-1 to 85-4 multiplex pixel samples read out from the RAMs 86-1 to 86-16 by the following process for each two pixels. In particular, pixel samples extracted two by two pixels from the first sub image and the second sub image are multiplexed in an adjacent relationship to each other on each odd-numbered pixel line of a frame of a class image prescribed by the UHDTV1. Similarly, pixel samples extracted two by two pixels from the third sub image and the fourth sub image are multiplexed in an adjacent relationship to each other on each even-numbered line of the class image prescribed by the UHDTV1. Then, into RAMs 84-1 to 84-4, the first to fourth class images are stored, respectively. The first to fourth class images are 3840×2160/100P-120P/4:4:4, 4:2:2, 4:2:0/10-bit, 12-bit signals.

A second two-pixel multiplexing control section 82 multiplexes pixel samples read out from the RAMs 84-1 to 84-4 by the following process for each two pixels. In particular, pixel samples are extracted from the class images of the UHDTV1 wherein the pixel samples are multiplexed two by two pixels by the first two-pixel multiplexing control sections 85-1 to 85-4. Then, from among the pixel samples extracted from each frame defined by the image signals of the class images, those pixel samples which are extracted two by two pixels from the first class image and the second class image are multiplexed in an adjacent relationship to each other on each odd-numbered line of a class image of the UHDTV2. The class image of the UHDTV2 is defined by a 7680×4320/100P, 119.88P, 120P/4:4:4, 4:2:2, 4:2:0/10-bit, 12-bit signal. Meanwhile, pixel samples extracted two by two pixels from the third class image and the fourth class image are multiplexed in an adjacent relationship to each other on each even-numbered line of the class image of the UHDTV2. Then, into a RAM 83, 7680×4320/100P, 119.88P, 120P/4:4:4, 4:2:2, 4:2:0/10 bits, 12 bits which are a class image prescribed by the UDHTV2 are stored, and the signals are reproduced suitably.

The clock supplying circuit 81 supplies a clock to the second two-pixel multiplexing control section 82, first two-pixel multiplexing control sections 85-1 to 85-4, line multiplexing control sections 87-1 to 87-16 and field multiplexing control sections 89-1 to 89-32. Further, the clock supplying circuit 81 supplies a clock to the word multiplexing control sections 91-1 to 91-64 and write control sections 93-1 to 93-128. By this clock, reading out or writing of pixel samples is controlled by the blocks synchronized with each other.

It is to be noted that FIG. 15 illustrates an example wherein first two-pixel multiplexing, second two-pixel multiplexing, line multiplexing, field multiplexing and word multiplexing are carried out at five stages using five different types of RAMS. However, a single RAM may alternatively be used to reproduce a 7680×4320/100P, 119.88P, 120P/4:4:4, 4:2:2, 4:2:0/10-bit, 12 bit signal.

With the transmission system 10 of the second embodiment described above, the sampling out process according to the present embodiment is carried out. In particular, a 7680×4320 signal having a great pixel number is sampled out twice in a unit of two pixel samples so as to be mapped to a plurality of 1920×1080 signals, and then line sampling out and field sampling out are carried out. This sampling out processing minimizes the memory capacity necessary to map a signal and can suppress also the transmission delay to a minimum level because the memory capacity is minimized.

Further, when 10G signals of 16 channels are to be transmitted by a single optical fiber, the CWDM/DWDM wavelength multiplexing technique can be used.

With the transmission systems 10 according to the first and second embodiments described hereinabove, an image of a very high resolution or very high capacity which corresponds to up to four times or 16 times that of the existing HD (1920×1080) can be transmitted. This image is configured from 3840×2160/120P signals or 7680×4320/120P signals. Then, at the stage of 3840×2160/120P signals or 7680×4320/120P signals including large pixel number, the pixel samples are sampled out once or twice two by two pixel samples to convert the signals into 1920×1080/120P signals of multiple channels. Further, at the state of the 1920×1080/120P signals, line sampling out is carried out to convert each of them into 1920×1080/120I signals of two channels. Then, the 1920×1080/120I signals are subjected to field sampling out to finally map them to 1920×1080/60I signals of 32 channels or 128 channels.

Further, a 3840×2160/100P-120P signal or a 7680×4320/100P-120P signal which may be proposed with high possibility in the future is subjected to two-pixel sampling out and line sampling out and finally to field sampling out. Consequently, the signals can be mapped to 1920×1080/50I-60I signals of multi-channels. The mapping method in the first and second embodiments described above requires the least memory capacity and exhibits a comparatively small delay. Further, the 1920×1080/50I-60I signal prescribed by the SMPTE 274M can be observed by an existing measuring instrument. Also it is possible to sample out a 3840×2160/100P-120P signal or a 7680×4320/100P-120P signal in a unit of a pixel or in a unit of a time period to observe the same. Further, since the method can match with various existing SMPTE mapping standards, it has high possibility that it may be approved of also in future standardization by the SMPTE.

By using the mapping method of the first and second embodiments described above, the following effects can be achieved.

(1) When 3840×2160/120P signals or 7680×4320/120P signals are transmitted at 10.692 Gbps in the mode D by four channels or 16 channels, the transmission system can be constructed with a minimum delay. Further, it is possible to cause the mapping method to match with the S2036-3, which is under consideration by the SMPTE, in that sampling out for every two pixel samples is carried out at the stage of a 3840×2160 signal or a 7680×4320 signal. It is to be noted that the S2036-3 relates to a mapping standard of 3840×2160/23.98P-60P or 7680×4320/23.98P-60P in the mode D for 10.692 Gbps in multi-channels.

(2) The number of pixels decreases and the memory capacity can be reduced. For line sampling out where it is carried out at the stage of a 1920×1080/120P signal to convert the same into 1920×1080/120I signals of two channels, a method adopted in the standard of the SMPTE 372 is used. In this standard, a method of mapping a 1920×1080/60P signal to 1920×1080/60I signals of two channels is prescribed. Therefore, the mapping method according to the embodiments can match with the mapping method prescribed by the standard of the SMPTE 372.

(3) Further, field sampling out is carried out at the stage of a 1920×1080/120I signal with which the memory capacity in a unit of a field is reduced to finally convert the same into a 1920×1080/60I signal. This 1920×1080/60I signal can be observed on an existing waveform monitor for the HD. For example, in the case of a 1920×1080/60I signal obtained by sampling out a 7680×4320/120P signal, it is sampled out to 1/16 in a unit of two pixel samples in FIG. 14. However, it is further sampled out in a unit of a line and/or a unit of field also in the time axis direction so that it is reduced until it is observed as ¼. Accordingly, an entire image of a 7680×4320/120P signal can be observed in a form in which it is sampled out in the pixel direction and the time direction.

Further, a 3840×2160/100P-120P signal and a 7680×4320/100P-120P signal which have not been defined by the SMPTE 274M or the like up to now are defined. Also 1920×1080/120P, 120I signals are defined. Therefore, a 3840×2160/100P-120P/4:4:4, 4:2:2, 4:2:0/10-bit, 12-bit signal of the UHDTV can be transmitted by a multi-channel 10G interface.

While preferred embodiments of the present invention have been described using specific terms, such description is for illustrative purpose, and it is to be understood that changes and variations may be made without departing from the spirit or scope of the following claims.

The present application contains subject matter related to that disclosed in Japanese Priority Patent Application JP 2010-039298 filed in the Japan Patent Office on Feb. 24, 2010, the entire content of which is hereby incorporated by reference.

What is claimed is:

1. A signal transmission apparatus, comprising:
a two-pixel sampling out control section adapted to sample out, from among pixel samples extracted from a class image defined by a 3840×2160/100P, 119.88P, 120P/4:4:4, 4:2:2, 4:2:0/10-bit, 12-bit signal of the UHDTV1 wherein the pixel number of one frame exceeds a pixel number prescribed by the HD-SDI format, two pixel samples adjacent each other on the same line by a method prescribed by the SMPTE 435-1 such that the pixel samples on each odd-numbered line of each frame are sampled out to a first sub image and a second sub image from among first to fourth sub images and the pixel samples on each even-numbered line of each frame are sampled out to the third sub image and the fourth sub image;
a line sampling out control section adapted to sample out the sample pixels in every other line of the first to fourth sub images mapped by said two-pixel sampling out control section to form interlace signals;
a field sampling out control section adapted to sample out the pixel samples sampled out for every other line for each field;
a word sampling out control section adapted to sample out the pixel samples sampled out for each field for each word to map the pixel samples to an active period of HD-SDIs of the mode D prescribed by the SMPTE 435-2; and
a readout control section adapted to output the HD-SDIs, UHDTV1 standing for Ultra High Definition Television, HD-SDI standing for High Definition Signal Digital Interface, SMPTE standing for Society of Motion Picture and Television Engineers.

2. The signal transmission apparatus according to claim 1, wherein said field sampling out control section applies the pixel samples from which odd-numbered fields and even-numbered fields of an image signal are sampled out alternately to two channels having a frame rate equal to one half that of the image signal.

3. The signal transmission apparatus according to claim 1, wherein said field sampling out control section maps, to a first channel from between the first channel and a second channel both having a frame rate equal to one half that of an image signal, the pixel samples included in odd-numbered fields of the image signal and maps, to the second channel, the pixel samples included in even-numbered fields of the image signal.

4. The signal transmission apparatus according to claim 2, further comprising a second two-pixel sampling out control section adapted to sample out, when a class image defined by a 7680×4320/100P, 119.88P, 120P/4:4:4, 4:2:2, 4:2:0/10-bit, 12-bit signal of the UHDTV2 is inputted, from among pixel samples extracted from the class image prescribed by the UHDTV2, two pixels adjacent to each other on the same line by a method prescribed by the SMPTE 435-1 such that the pixel samples on the odd-numbered lines of each frame are sampled out alternately so as to be mapped to a first class image and a second class image from among the first to fourth class images prescribed by the UHDTV1 and the pixel samples on the even-numbered lines of each frame are sampled out alternately so as to be mapped to the third class image and the fourth class image;
said second pixel sampling out control section mapping the pixel samples extracted from the first to fourth class images to the first to fourth sub images, respectively.

5. The signal transmission apparatus according to claim 3, further comprising a second two-pixel sampling out control section adapted to sample out, when a class image defined by a 7680×4320/100P, 119.88P, 120P/4:4:4, 4:2:2, 4:2:0/10-bit, 12-bit signal of the UHDTV2 is inputted, from among pixel samples extracted from the class image prescribed by the UHDTV2, two pixels adjacent to each other on the same line by a method prescribed by the SMPTE 435-1 such that the pixel samples on the odd-numbered lines of each frame are sampled out alternately so as to be mapped to a first class image and a second class image from among the first to fourth class images prescribed by the UHDTV1 and the pixel samples on the even-numbered lines of each frame are sampled out alternately so as to be mapped to the third class image and the fourth class image;
said second pixel sampling out control section mapping the pixel samples extracted from the first to fourth class images to the first to fourth sub images, respectively.

6. A signal transmission method, comprising the steps of:
sampling out, from among pixel samples extracted from a class image defined by a 3840×2160/100P, 119.88P, 120P/4:4:4, 4:2:2, 4:2:0/10-bit, 12-bit signal of the UHDTV1 wherein the pixel number of one frame exceeds a pixel number prescribed by the HD-SDI format, two pixel samples adjacent each other on the same line by a method prescribed by the SMPTE 435-1 such that the pixel samples on each odd-numbered line of each frame are sampled out to a first sub image and a second sub image from among first to fourth sub images and the pixel samples on each even-numbered line of each frame are sampled out to the third sub image and the fourth sub image;
sampling out the sample pixels in every other line of the mapped first to fourth sub images to form interlace signals;
sampling out the pixel samples sampled out for every other line for each field;
sampling out the pixel samples sampled out for each field for each word to map the pixel samples to an active period of HD-SDIs of the mode D prescribed by the SMPTE 435-2; and
outputting the HD-SDIs,
UHDTV1 standing for Ultra High Definition Television, HD-SDI standing for High Definition Signal Digital Interface, SMPTE standing for Society of Motion Picture and Television Engineers.

7. A signal reception apparatus, comprising:
a write control section adapted to store HD-SDIs of the mode D prescribed by the SMPTE 435-2 into a storage section;
a word multiplexing control section adapted to multiplex pixel samples extracted from an active period of the HD-SDIs read out from said storage section for each word;
a field multiplexing control section adapted to multiplex the pixel samples multiplexed for each word for each field;
a line multiplexing control section adapted to multiplex the pixel samples multiplexed for each field to first to fourth sub images for each line to produce progressive signals; and
a two-pixel multiplexing control section adapted to multiplex the pixel samples extracted two by two pixels from the first sub image and the second sub image in an adjacent relationship to each other on odd-numbered lines in a class image prescribed by the UHDTV1 of an image signal which is a 3840×2160/100P, 119.88P, 120P/4:4:4, 4:2:2, 4:2:0/10-bit, 12-bit signal of the UHDTV1 and multiplex the pixel samples extracted two by two pixels from the third sub image and the fourth sub image in an adjacent relationship to each other on even-numbered lines of a frame,
UHDTV1 standing for Ultra High Definition Television, HD-SDI standing for High Definition Signal Digital Interface, SMPTE standing for Society of Motion Picture and Television Engineers.

8. The signal reception apparatus according to claim 7, wherein said field multiplexing control section multiplexes the pixel samples in the odd-numbered fields included in first and second channels from between first and second channels in which the pixel samples are multiplexed by said word multiplexing control section and which have a frame rate equal to twice that of the HD-SDIs alternately to the odd-numbered fields of one of the channels which have the frame rate equal to twice that of the HD-SDIs and multiplexes the pixel samples in the even-numbered fields included in the first and second channels alternately to the even-numbered fields of one of the channels which have the frame rate equal to twice that of the HD-SDIs.

9. The signal reception apparatus according to claim 7, wherein said field multiplexing control section multiplexes the pixel samples included in a first channel from between first and second channels in which the pixel samples are multiplexed by said word multiplexing control section and which have a frame rate equal to twice that of the HD-SDIs to the odd-numbered fields of one of the channels which have the frame rate equal to twice that of the HD-SDIs and multiplexes the pixel samples included in the second channel to the even-numbered fields of one of the channels which have the frame rate equal to twice that of the HD-SDIs.

10. The signal reception apparatus according to claim 8, further comprising a second two-pixel multiplexing control section adapted to multiplex the pixel samples extracted two by two pixels from the first class image and the second class image from among the pixel samples extracted from first to fourth class images defined by an image signal which is the 3840×2160/100P, 119.88P, 120P/4:4:4, 4:2:2, 4:2:0/10-bit, 12-bit signal of the UHDTV1 in an adjacent relationship to each other on the odd-numbered lines of the class image defined by a 7680×4320/100P, 119.88P, 12OP/4:4:4, 4:2:2, 4:2:0/10-bit, 12-bit signal of the UHDTV2 and multiplex the pixel samples extracted two by two pixels from the third class image and the fourth class image in an adjacent relationship to each other on the even-numbered lines of the class image of the UHDTV2.

11. The signal reception apparatus according to claim 9, further comprising a second two-pixel multiplexing control section adapted to multiplex the pixel samples extracted two by two pixels from the first class image and the second class image from among the pixel samples extracted from first to fourth class images defined by an image signal which is the 3840×2160/100P, 119.88P, 120P/4:4:4, 4:2:2, 4:2:0/10-bit, 12-bit signal of the UHDTV1 in an adjacent relationship to each other on the odd-numbered lines of the class image defined by a 7680×4320/100P, 119.88P, 120P/4:4:4, 4:2:2, 4:2:0/10-bit, 12-bit signal of the UHDTV2 and multiplex the pixel samples extracted two by two pixels from the third class image and the fourth class image in an adjacent relationship to each other on the even-numbered lines of the class image of the UHDTV2.

12. A signal reception method, comprising the steps of:
storing HD-SDIs of the mode D prescribed by the SMPTE 435-2 into a storage section;
multiplexing pixel samples extracted from an active period of the HD-SDIs read out from the storage section for each word;
multiplexing the pixel samples multiplexed for each word for each field;
multiplexing the pixel samples multiplexed for each field to first to fourth sub images for each line to produce progressive signals; and
multiplexing the pixel samples extracted two by two pixels from the first sub image and the second sub image in an adjacent relationship to each other on odd-numbered lines in a class image prescribed by the UHDTV1 of an image signal which is a 3840×2160/100P, 119.88P, 120P/4:4:4, 4:2:2, 4:2:0/10-bit, 12-bit signal of the UHDTV1 and multiplexing the pixel samples extracted two by two pixels from the third sub image and the fourth sub image in an adjacent relationship to each other on even-numbered lines of a frame,
UHDTV1 standing for Ultra High Definition Television, HD-SDI standing for High Definition Signal Digital Interface, SMPTE standing for Society of Motion Picture and Television Engineers.

13. A signal transmission system, comprising:
a signal transmission apparatus including
a two-pixel sampling out control section adapted to sample out, from among pixel samples extracted from a class image defined by a 3840×2160/100P, 119.88P, 120P/4:4:4, 4:2:2, 4:2:0/10-bit, 12-bit signal of the UHDTV1 wherein the pixel number of one frame exceeds a pixel number prescribed by the HD-SDI format, two pixel samples adjacent each other on the same line by a method prescribed by the SMPTE 435-1 such that the pixel samples on each odd-numbered line of each frame are sampled out to a first sub image and a second sub image from among first to fourth sub images and the pixel samples on each even-numbered line of each frame are sampled out to the third sub image and the fourth sub image,
a line sampling out control section adapted to sample out the sample pixels in every other line of the first to fourth sub images mapped by said two-pixel sampling out control section to form interlace signals,
a field sampling out control section adapted to sample out the pixel samples sampled out for every other line for each field,
a word sampling out control section adapted to sample out the pixel samples sampled out for each field for each word to map the pixel samples to an active period of HD-SDIs of the mode D prescribed by the SMPTE 435-2, and
a readout control section adapted to output the HD-SDIs; and
a signal reception apparatus including
a write control section adapted to store HD-SDIs of the mode D prescribed by the SMPTE 435-2 into a storage section,
a word multiplexing control section adapted to multiplex pixel samples extracted from an active period of the HD-SDIs read out from said storage section for each word,
a field multiplexing control section adapted to multiplex the pixel samples multiplexed for each word for each field,
a line multiplexing control section adapted to multiplex the pixel samples multiplexed for each field to first to fourth sub images for each line to produce progressive signals, and
a two-pixel multiplexing control section adapted to multiplex the pixel samples extracted two by two pixels from the first sub image and the second sub image in an adjacent relationship to each other on odd-numbered lines in a class image defined by the 3840×2160/100P, 119.88P, 120P/4:4:4, 4:2:2, 4:2:0/10-bit, 12-bit signal of the UHDTV1 and multiplex the pixel samples extracted two by two pixels from the third sub image and the fourth sub image in an adjacent relationship to each other on even-numbered lines of the frame,
UHDTV1 standing for Ultra High Definition Television, HD-SDI standing for High Definition Signal Digital Interface, SMPTE standing for Society of Motion Picture and Television Engineers.

14. A signal transmission apparatus, comprising:
two-pixel sampling out control means for sampling out, from among pixel samples extracted from a class image defined by a 3840×2160/100P, 119.88P, 12OP/4:4:4, 4:2:2, 4:2:0/10-bit, 12-bit signal of the UHDTV1 wherein the pixel number of one frame exceeds a pixel number prescribed by the HD-SDI format, two pixel samples adjacent each other on the same line by a method prescribed by the SMPTE 435-1 such that the pixel samples on each odd-numbered line of each frame are sampled out to a first sub image and a second sub image from among first to fourth sub images and the pixel samples on each even-numbered line of each frame are sampled out to the third sub image and the fourth sub image;
line sampling out control means for sampling out the sample pixels in every other line of the first to fourth sub images mapped by said two-pixel sampling out control means to form interlace signals;
field sampling out control means for sampling out the pixel samples sampled out for every other line for each field;
word sampling out control means for sampling out the pixel samples sampled out for each field for each word to map the pixel samples to an active period of HD-SDIs of the mode D prescribed by the SMPTE 435-2; and
readout control means for outputting the HD-SDIs,
UHDTV1 standing for Ultra High Definition Television, HD-SDI standing for High Definition Signal Digital Interface, SMPTE standing for Society of Motion Picture and Television Engineers.

15. A signal reception apparatus, comprising:
write control means for storing HD-SDIs of the mode D prescribed by the SMPTE 435-2 into storage means;
word multiplexing control means for multiplexing pixel samples extracted from an active period of the HD-SDIs read out from said storage means for each word;
field multiplexing control means for multiplexing the pixel samples multiplexed for each word for each field;
line multiplexing control means for multiplexing the pixel samples multiplexed for each field to first to fourth sub images for each line to produce progressive signals; and
two-pixel multiplexing control means for multiplexing the pixel samples extracted two by two pixels from the first sub image and the second sub image in an adjacent relationship to each other on odd-numbered lines in a class image prescribed by the UHDTV1 of an image signal which is a 3840×2160/100P, 119.88P, 120P/4:4:4, 4:2:2, 4:2:0/10-bit, 12-bit signal of the UHDTV1 and multiplexing the pixel samples extracted two by two pixels from the third sub image and the fourth sub image in an adjacent relationship to each other on even-numbered lines of a frame,
UHDTV1 standing for Ultra High Definition Television, HD-SDI standing for High Definition Signal Digital Interface, SMPTE standing for Society of Motion Picture and Television Engineers.
